(19) United States
(12) Patent Application Publication
(10) Pub. No.: US 2001/0034717 A1
(43) Pub. Date: Oct. 25, 2001

(54) Fraud resistant credit card using encryption, encrypted cards on computing devices

(76) Inventor: Brian L. Whitworth, Malibu, CA (US)

Correspondence Address: HENRICKS SLAVIN AND HOLMES LLP, SUITE 200, 840 APOLLO STREET, EL SEGUNDO, CA, 90245

(21) Appl. No.: 09/764,369

(22) Filed: Jan. 17, 2001

Related U.S. Application Data
(60) Provisional application No. 60/182,626, filed on Feb. 15, 2000.

(51) Int. Cl. G06F 17/60; H04K 1/00; H04L 9/00

(52) U.S. Cl. 705/64; 713/168

(57) ABSTRACT

Methods of providing fraud-resistant credit cards, debit cards, ATM cards, identification, and access control on a variety of devices are provided. Various devices and combinations of devices can be used for a single card or account. Multiple cards or accounts, potentially with differing security arrangements, can be embodied on the same device. Variable account numbers and encryption algorithms compatible with current point of sale systems are disclosed. Methods of displaying information in forms readable by humans and machines are also disclosed, as well as methods for providing machine-readable information on smaller displays.

### CROSS-REFERENCE TO RELATED APPLICATION

This application claims the benefit, in part, based upon U.S. Provisional application entitled Fraud Resistant Credit Card Using Encryption, No. 60/182,626, filed on Feb. 15, 2000.

### BACKGROUND OF THE INVENTION

1. Field of the Invention

The present invention relates to credit cards, debit cards and ATM cards which have improved resistance to fraud and theft using encryption and time codes within the cards themselves. A second embodiment is included for similar cards which are designed to provide identification or security access. A third embodiment is included for using similar procedures to enhance security for internet or local area network password access.

2. Description of the Related Art

Smart Cards

Currently, smart cards perform a variety of tasks. These cards are able to store information which may change over time, such as the amount of value left on the card for a prepaid phone card or a person's security clearance.

Smart cards use a variety of methods of confirming identification. At this time, however, smart cards do not directly display data in a form which can be read by both humans and machines. The cards must be placed in some form of device or reader in order to extract data which changes over time, such as the remaining balance on the card.

Some smart cards, particularly those used for identification at specified sites, use a physical characteristic of the cardholder to confirm identification (e.g., fingerprints Abtahi, et al, U.S. Pat. No. 5,509,083). In some cases, a data regarding the characteristic is recorded on the card itself. In other cases, that data is stored remotely.

Credit Cards

Credit card theft and fraud cost billions of dollars each year in the United States alone. Numerous attempts have been made to create credit cards which lower the incidence of theft and fraud. Most of this art consists of confirming the identity of the cardholder.

Bar Codes

Bar codes have been successful for a number of uses. They are easily readable by machines from many angles and in a broad range of temperature, humidity, and electric and magnetic field conditions. Bar codes also typically include numbers readable by humans which match the bar codes which are readable by machines. This leads to a convenient backup system in case a bar code reader is not working properly or the bar code is partially smeared or otherwise obscured. These factors have led to widespread use of bar codes and bar code equipment in retail stores.

Common uses of bar codes include pricing, inventory, and identification of merchandise. Special bar codes are used for books and magazines, under the ISBN standard. Other bar codes have been adapted for mailing and addressing. In some cases, bar codes have been used as a method of identification, such as the Ralph's Club cards issued by Ralph's Groceries. In those cases where bar codes have been used for identification, they serve as an alternative to keying in a sequence of numbers or reading a magnetic stripe. Bar codes currently are printed on paper or similar media and when used on identification do not change from one use of the card to the next use of the same card.

Problems with Current Methods of Confirming Identity of Cardholders

Current methods of confirming the identity of a cardholder suffer from at least one of the following problems.

1) The method of confirming identity is dependent on the clerk, cashier, telemarketer, waiter, or other person accepting the card. In-person confirmations, such as showing a photo ID are subject to the honesty and skill level of the person accepting the card. In many instances, the person accepting the card is the same person who will attempt to defraud the credit card company. Thus, a cashier with a stolen credit card number is often able to circumvent the normal verification process. In other instances, busy or poorly trained personnel will simply do a poor job of following normal verification procedures. Criminals are well aware of this and will often choose particular stores or times when verification is likely to be lax to attempt credit card fraud.

2) The method of confirming identity usually works in person, but is difficult or impossible over the phone or the Internet. A common example of this problem is the inability to check a photo ID or fingerprint over the phone or the Internet without special additional equipment. This can lead to unauthorized charges by persons who would never be mistaken for the real cardholder, such as a 10 year-old girl who has “borrowed” her mother's card without her knowledge and ordered merchandise over the Internet.

3) The method of confirming identity usually works over the Internet, but not over the phone or in person.

4) The method of confirming identification is subject to being circumvented by someone looking over the cardholder's shoulder, or being overheard. A common example is seeing someone's PIN number as they key it in at the grocery checkout lane. If a criminal is also able to get a discarded receipt or see the credit card number, they may be well on their way to fraudulent charges on a card they have never touched.

5) Certain methods of confirming identification using physical characteristics of the cardholder are subject to creative copying or circumvention. For example, some fingerprint verification systems have been defeated by use of a copy of a fingerprint from the cardholder. A typical wallet will not only contain credit cards and identification, but also several retrievable fingerprints on the wallet and its contents. Using evaporation of super glue, a technique pioneered by law enforcement, criminals can extract fingerprint information from paper, leather, plastic and many other surfaces. Many of the places from which a credit or identification card might be stolen contain dozens of retrievable fingerprints. A house, office or car will usually be virtually covered in useable fingerprints.

6) The method of confirming identity may require devices which are expensive or are not widely used.

7) The card number and/or identifying information can be intercepted during the verification process by persons who are not physically present. A large amount of the prior art attempts to deal with this problem by making the transmission of the data secure (e.g., Rowney, et. al., US5987140), rather than using a method of verification which makes intercepted data from one charge useless for a later attempted charge.

8) Repositories of credit card numbers retained for the convenience of cardholders (e.g., internet account numbers at www.creditcards.com who recently had a whole database of credit card numbers stolen), can sometimes be broken into and huge numbers of customers can be defrauded at once.

Problems with the Cards Themselves

Typical current credit cards have at least one of the following problems:

1) The credit card's magnetic strip can be copied with a simple device. Making copies in this manner is as easy as using a Xerox machine to copy a page of text. Thus, a second card could be used in parallel to the first. If the original card is still in the possession of the cardholder, they may think nothing is wrong until the credit card company calls or they receive an unusually high bill. This is also a weakness of encoding physical information on the card's magnetic strip. The data on the strip can be read and imitated, such as with a fingerprint.

2) The credit card information is displayed at all times, regardless of whether it is in the possession of the cardholder: anyone who can look over your shoulder, see an open wallet, or snoop in an unattended purse can read and copy the necessary cardholder name, account number, and expiration date.

3) If the necessary information is copied and someone attempts fraudulent charges, the original card must be cancelled and a new one issued before the cardholder can resume normal use of their account. This can be a major cause of inconvenience during the time it takes to reissue a card.

4) The credit card itself provides exactly the same information each time it is presented for payment. Thus, anyone able to get the necessary information once is likely to be able to make several charges before anyone notices, even if the thief does not have the card itself.

5) Credit cards accommodate one account per card. Thus, many people carry many different cards which have different purposes or are issued by different institutions.

Typical current smart cards have at least one of the following problems:

1) Smart cards do not directly display data in a form which can be read by both humans and machines. The cards must be placed in some form of device or reader in order to extract data which changes over time, such as the remaining balance on the card. This prevents smart cards from being easily used by humans for phone orders. Special readers are necessary for usage with Internet orders.

2) Smart card readers vary considerably. Currently, the data on smart cards which changes from one use to another is not displayed in bar code fashion.

Social Security, Driver's Licenses, Access Cards and Other Identification

A second embodiment is included for identification cards. The average person has several forms of identification which are not directly used for financial transactions. Most American adults have a social security card and a driver's license. Many also have a passport or identification for their workplace or educational institution. For all of these forms of identification, it is possible for other persons to cause considerable damage by making forged copies or unauthorized duplicates of the original. For example, a fake social security card can be used to get a real driver's license from the state with the thief's picture and handwriting. After obtaining the driver's license, the thief can obtain credit cards or loans using the real person's credit. He may also drive drunk, get married, or conduct other activities which can be very hard for the real person to find and correct in the public record.

Any of these pieces of identification can be replaced by a card similar to the credit, debit or ATM cards described in the primary embodiment. Such identification and methods of verification would render fake documents created without copying real documents virtually useless. Such identification would also be much harder to copy from a real document, since the real document must be in the possession of the forger and much of the critical information is difficult or impossible to access without damaging the original.

Internet or Local Area Network Access Control

A third embodiment is included for internet or local area network password access. This embodiment is provided for confirming the identity of users who wish to access sites or systems via the internet or a local area network. For many systems, especially those involving financial transactions, intercepting a password may allow an unauthorized person to perform transactions as if they were the real user. This ability to intercept information and perform financial transactions on someone else's account has many characteristics in common with credit card fraud. Time sensitive encryption code access provides increased security for internet or LAN access in a manner similar to that described in the primary embodiment for credit cards, debit cards and ATM cards.

Accordingly, it is an object of the present invention to provide a method for creating credit cards, debit cards, and ATM cards which are resistant to fraud or theft by any means where credit card information from prior transactions are obtained.

It is another object of the present invention to provide a method for improved security of access to the card.

It is another object of the present invention to provide improved security and fraud protection for identification such as driver's licenses, Social Security cards, passports, and building access cards.

It is another object of the present invention to provide a method of accessing internet sites using a program which provides information in a manner which reduces chances of fraud or theft by any means where login, password, or identification information from prior transactions are obtained.

It is another object of the present invention to provide methods of installing and activating software for encrypted virtual cards.

It is another object of the present invention to provide methods of displaying barcodes on a variety of devices which can host credit cards, debit cards and ATM cards which are resistant to fraud.

### SUMMARY OF THE INVENTION

In accordance with an exemplary preferred embodiment of the present invention, a fraud-resistant credit card using encryption and a display directly readable by humans includes a credit or identification card containing: a timing device; an encryption code which is unique for each card; a method for displaying an encrypted code which is derived from the time at which the card is used; a display on the card which is readable by humans and current bar code hardware, said display can display the card's time, card number, and encrypted code number.

In another aspect of the present invention, a serial code, showing the number of uses of the card can be substituted for the timing device.

In another aspect of the present invention, the device can also have a control mechanism for turning on the card or the card's display which enhances the card's security using methods such as using a PIN number or a fingerprint.

In another aspect of the present invention, a portable electronic device with a display can be substituted for the credit card or identification card.

In another aspect of the present invention, simple methods for installing software and activating cards are provided.

In another aspect of the present invention, methods for deactivating old cards are provided.

In another aspect of the present invention, methods for accepting deposits are provided.

In another aspect of the present invention, methods for upgrading software or host device(s) are provided.

In another aspect of the present invention, methods of handling recurring transactions are provided.

In another aspect of the present invention, methods of accepting deposits are provided.

In another aspect of the present invention, methods of displaying necessary information on device displays using barcodes are provided.

### DESCRIPTION OF THE DRAWINGS

Other objects, features and advantages of the invention will become readily apparent upon reference to the following detailed description when considered in conjunction with the accompanying drawings, in which like reference numerals designate like parts throughout the figures thereof, and wherein:

FIG. 1 is a high level functional flowchart of an exemplary preferred embodiment of the present invention.

FIG. 2 is a functional flowchart illustrating steps of an exemplary preferred method for usage of a credit card, debit card, or ATM card.

FIG. 3 is a functional flowchart illustrating steps of providing card or account information for different methods of making financial transactions using a credit card, debit card, or ATM card.

FIG. 4 is a chart showing methods of inputting information from the card for various purchase methods and types of cards.

FIG. 5 is a detailed drawing of an exemplary credit card, debit card, ATM card or identification card which uses a PIN number to access the card.

FIG. 6 is a functional flowchart showing usage of an identification card.

FIG. 7 displays a method of generating secure information for internet logins or transactions.

FIG. 8 is a functional flowchart showing methods for accommodating recurring charges.

FIG. 9 is a functional flowchart showing methods of installing card software.

FIG. 10 is a functional flowchart showing activation of card software for an account or identification.

FIG. 11 is a functional flowchart showing methods of deactivating cards or devices.

FIG. 12 is a chart showing applications where the same card or account is embodied on multiple devices

FIG. 13 a functional flowchart showing methods by which other software may prompt card transactions.

FIG. 14 is a functional flowchart showing methods by which information regarding card transactions may be used by other software.

FIG. 15 is a chart summarizing types of images which may be displayed by a device upon which a card is embodied.

FIG. 16 is a functional flowchart showing an exemplary method for sending encrypted and unencrypted cardholder information to an approval center.

FIG. 17 is a chart summarizing methods of fitting bar coded information on device displays.

### DETAILED DESCRIPTION OF THE PREFERRED EMBODIMENTS

An exemplary preferred embodiment of the present invention is adapted to provide a method for creating and using credit cards, debit cards and ATM cards which have improved resistance to fraud and theft using encryption and time codes within the cards themselves. A second embodiment is included for similar cards which are designed to provide identification or security access. A third embodiment is included for using similar procedures to enhance security for internet or local area network password access.

Major Inputs and Outputs

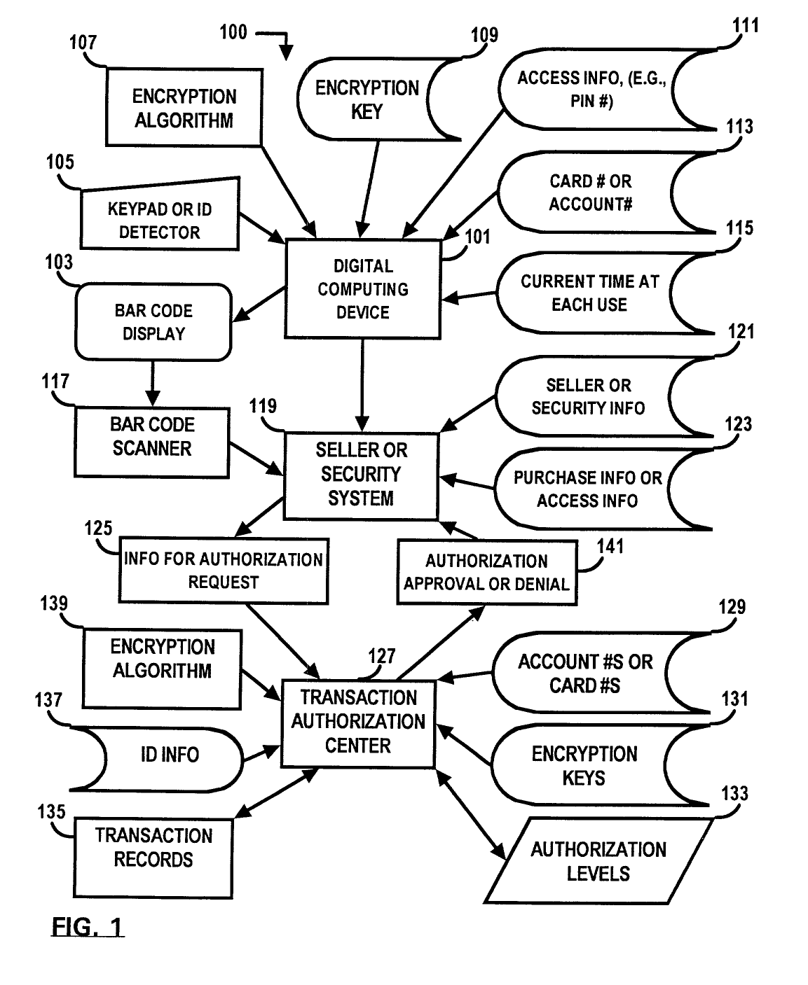

Referring to FIG. 1, an exemplary preferred system 100 according to the present invention includes a digital computing device 101, for example, a smart card with and LCD display, a Palm Pilot, or a personal computer. The digital computing device 101 has a bar code display 103, a keypad or user identification detector 105, and is programmed with an encryption algorithm 107. The keypad or user identification detector 105, can take many forms, such as a keypad which accepts a password or a pin number, a fingerprint reader, or a retinal scanner. The bar code display 103 is optional and is used only for certain applications.

A unique encryption key 109 is used for each installation, account, or digital computing device. The digital computing device 101, uses several inputs. Access information 111, such as a pin number or fingerprint, is used to obtain access to the digital computing device 101. One or more card numbers or account numbers 113 are stored on the digital computing device 101. The current time at each use 115 is obtained from an internal clock.

For many applications, a readout on a bar code display 103, is scanned by a bar code scanner 117 and the information is transmitted to a seller or security system 119. In other applications, information is sent directly from the digital computing device 101 to the seller or security system 119. The seller or security system 119 also uses seller or security information 121. Such information might include a store name, a merchant number, or a security access number. Information regarding items to be purchased or access being requested is also input 123.

Information from the seller or security system 119, is sent as an authorization request 125 to a transaction authorization center 127. Such authorization center might be a credit card authorization center, a center for security clearance, or a bank. The transaction authorization center 127 also uses data regarding account numbers or card numbers 129, encryption keys 131, authorization levels 133, transaction records 135, identification information 137 and one or more encryption algorithms 139. The transaction information center generates authorization approvals or denials 141. After a transaction is completed, transaction records 135 are updated, and any appropriate changes are made in authorization levels 133.

Financial Transactions in Person

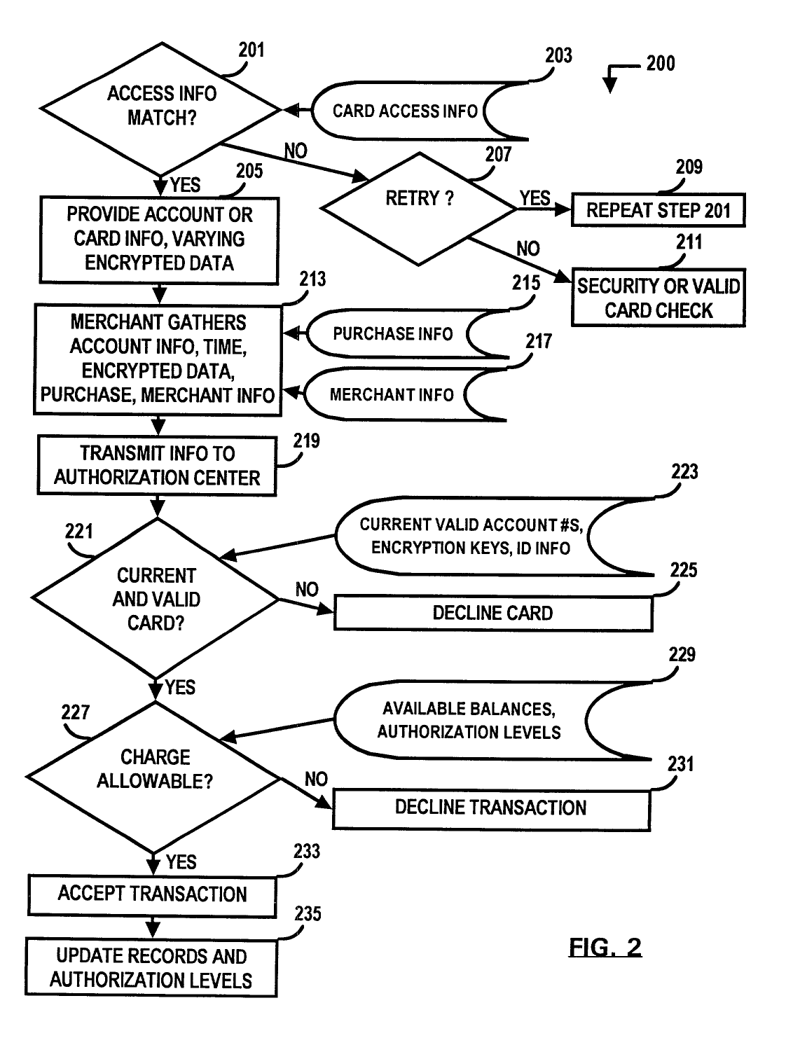

FIG. 2 illustrates steps of an exemplary preferred method 200 for usage of a credit card, debit card, or ATM card. In order to access the card and attempt a transaction, card access information 203 is provided by the user and compared with access information on the card itself to determine if both sets of information match 201. Card access information can come in many forms. For example, access information might involve a PIN number, a password, a fingerprint, voice activation, a retinal image, or an old-fashioned metal key. For high-security applications, multiple types of access info might be required on the same card, such as both voice activation and a PIN number.

For some applications, cost effectiveness might dictate making a card with no access control mechanism. Such a card would have access similar to a current plastic credit card, which is always “on”, a current plastic card's information is always available, regardless of who has possession of the card. On current credit cards, the card's information is available even when lost, stolen, or “borrowed” by friends or family members. Once a card has a display which is capable of changing, nothing prevents use of the same card for multiple accounts. Different accounts might be accessed from the same card with different PIN numbers, for example.

If the access information does not match at 201, a “no” advances to 207 where a decision is made regarding retrying providing access information for the card. If the user would like to retry accessing the card, a “yes” advances to 209 and allows the user to retry providing card access information 201. If there is concern about whether an improper person is attempting to access the card, concern about whether the card is valid, or concerns about whether the card may be an attempted copy or counterfeit, a “no” advances to 211, where a security or valid card check is performed.

If card access information 201 does match, the card itself provides information 205 which may include: card number, account number, cardholder name(s), expiration date, usage restriction information, date according to the card's clock, time according to the card's clock, number of times the card has been used, and an encrypted code related to such information.

For technical reasons, it is likely that the encrypted code will be related to number of card uses, time or time and date information. The card information and an encrypted code related to that information will be used to confirm that the card is an original and in the physical possession of the cardholder at the time a transaction is attempted. The encrypted information should vary from one attempted transaction to the next in a way which the transaction center will be able to confirm, but forgers and thieves cannot usefully guess, intercept or copy.

For example, the encrypted code might be based on year, month, day, hour, minute, and second at which the card is accessed. In this case, even the fastest users would access the card a few seconds later for the next attempted transaction. The card's time would change, as would the encrypted code based on the time. This encrypted code would change in a way which is not predictable to anyone who does not have the encryption key for that particular card. Most likely, the encryption key is only stored in two places: on the user's card, in a manner which is very difficult or impossible to get to without possessing and mutilating the card; and on the information system of the transaction center.

It is this additional bit of changing encrypted data which cannot be easily guessed that will reduce or eliminate certain types of credit card fraud. Credit card slips from prior charges are useless for attempting new charges, since they do not provide the new encrypted data required for a subsequent transaction. Similarly, account statements, receipts, photocopies of a card, intercepted internet orders, and card numbers overheard during a phone order are rendered useless to potential thieves.

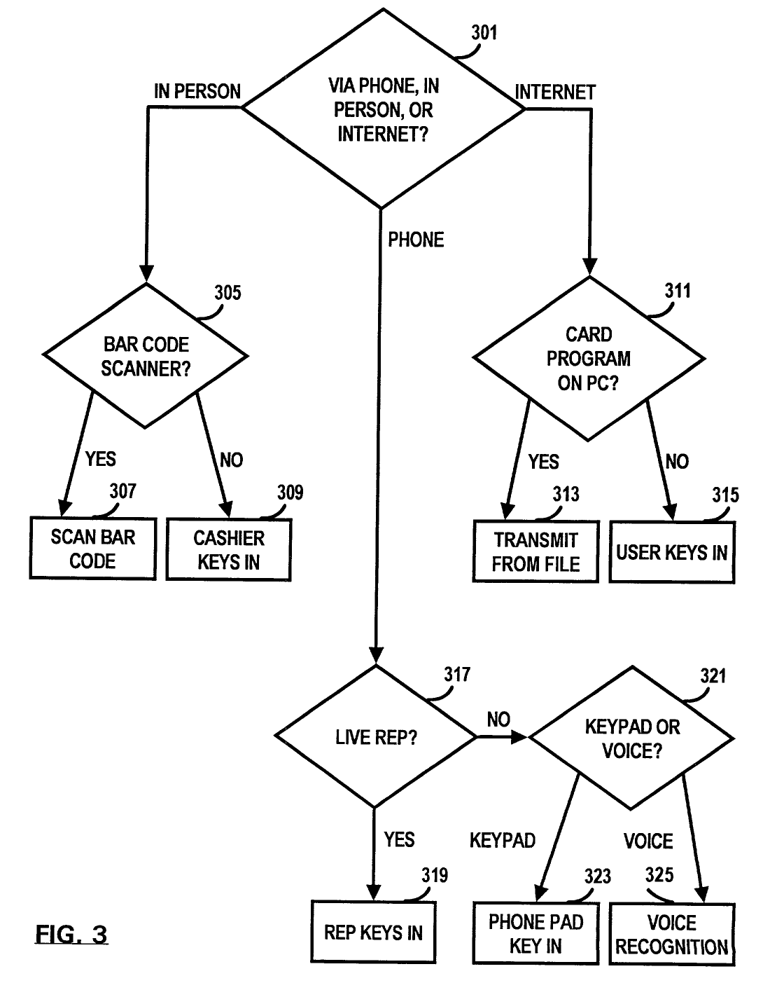

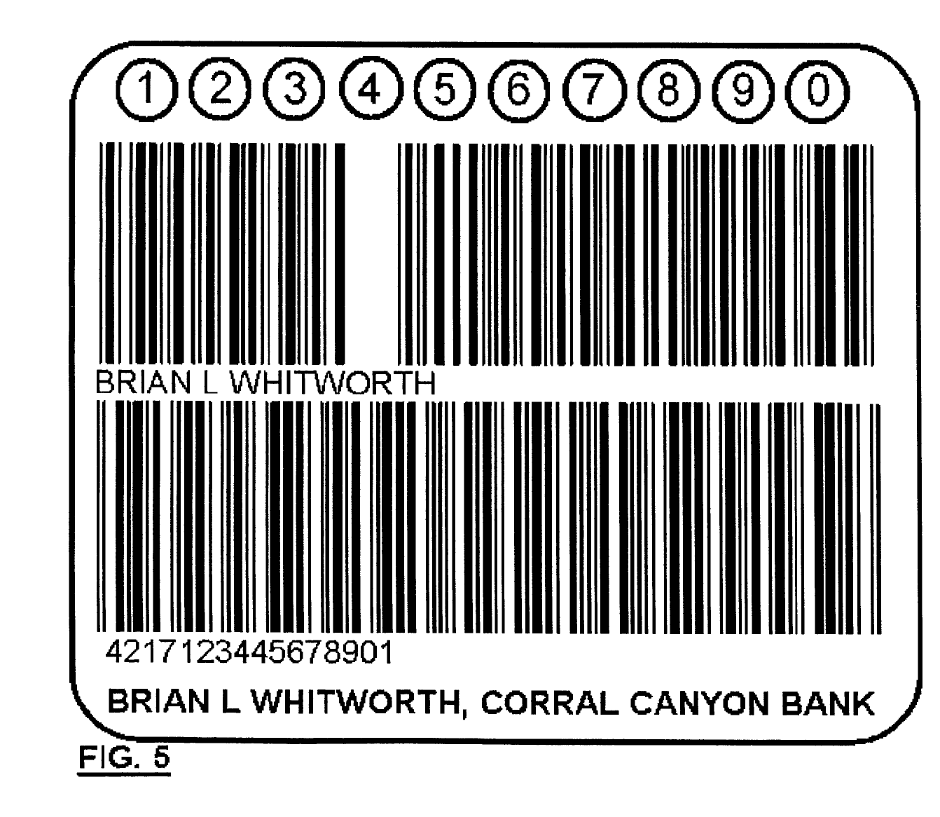

The card itself can provide information 205 in a variety of ways. Several different methods are shown in FIG. 3. The “card” can even be a program on a handheld computing device or a computer. One preferential embodiment is a card of similar size to a current credit card where information is displayed on a liquid crystal display (LCD), a detail drawing of which is shown in FIG. 5. This LCD can display data in a form directly readable by humans and by bar code scanners. Thus, the card can be used in person, for phone orders, and for internet orders with similarly high levels of security.

The merchant will input additional information regarding purchases 215 and the merchant 217. This merchant information is bundled along with information provided by the card 213 and transmitted to the authorization center 219. The data transmitted to the authorization center can be similar to data transmitted using current methods, except that encrypted data which changes with each use of the card is included.

The transaction center will use information on current valid account numbers or card numbers, encryption keys, and any identification information which might also be transmitted 223 to determine whether the requested transaction involves a current and valid card 221. If the card is not current or valid, a “no” results in the card being declined 225.

If the card is current and valid, a “yes” causes the transaction center to determine if the charge is allowable 227. Determining if a charge is allowable can be done using current means which compare the requested transaction with information such as available balances and authorization levels 229. If the charge is not allowable, the transaction is declined 231. If the charge is allowable, the transaction center accepts the transaction 233 and makes any necessary updates in records and authorization levels 235.

Note that this method of using encrypted data based authorization is also backward compatible. It is possible for a transaction authorization center to authorize current plastic cards and encryption based cards concurrently. Encryption based cards would have a much better level of security, but the same system could be used for traditional plastic cards. For plastic cards, the steps for input and matching of encrypted data are simply ignored, or the system effectively treats all plastic cards as if they had an encryption code which always matches.

Methods of Providing Card or Account Information

FIG. 3 illustrates steps of providing card or account information for different methods of making financial transactions using a credit card, debit card, or ATM card. As mentioned above, the “card” can also be a program on a handheld computing device or a computer.

The method of providing information depends on the method by which merchandise or services are being purchased, for example: in person, via phone, or via the internet 301. If the method of purchase is in person, the method of providing data depends on whether the merchant uses a bar code scanner 305. If “yes” the merchant will scan the bar code display on the card 307, which includes encrypted data as described in FIG. 2. Since a handheld computing device or a computer can display bar codes, these can also be used in place of the card. If the merchant does not use a bar code scanner, the card information can be read and input by a cashier, waiter, salesperson, clerk, etc. 309. Inputting card information by hand also works as a fallback or transitional method for a merchant whose bar code system is not yet programmed for reading credit cards, or whose system is temporarily down.

For internet orders, the user will have different card or account information input procedures depending on whether the user has a virtual card program on his or her computer 311. Similar methods to those used to create a encryption-based card with a display can be used to create a program on a computer which functions in a like manner.

Any computer connected to the internet, a local area network, or similar communications system will require safeguards to prevent unauthorized copying of such a program. There are an assortment of such unauthorized copying safeguards which are familiar to computer programmers and computer manufacturers. Certain synergies become possible if the card is replaced by a program on the user's computer. One such synergy is the ability to integrate the card-emulation program with accounting or tax software. This integration would be popular with businesses whose employees make large numbers of expense account purchases and individuals who wish to simplify bookkeeping.

If a card-emulation program runs on the user's computer, a “yes” advances to 313, where card or account information for a purchase is made directly from the user's computer. If the user is not running a card-emulation program, the user keys in card or account information by hand 315. Regardless of which method is used for inputting purchase information via the internet, enhanced information security will result. If a credit card transaction is intercepted, or information from a website is accessed by unauthorized persons, information from prior transactions is useless in attempts at later fraudulent transactions.

For phone transactions, the method of inputting data is different depending on whether data is taken by a live human representative 317. If information is being taken by a live representative, the representative keys in said information 319. If the information is not taken by a live representative, a “no” at 317 advances to another decision regarding whether the information is entered by the user on the user's phone keypad or is spoken by the user and analyzed by voice recognition software 321. If the method is “keypad”, the user keys in card or account information on their phone's keypad 323. For “voice”, the user says the necessary information and voice recognition 325 translates the necessary data.

Methods of Inputting Card Information

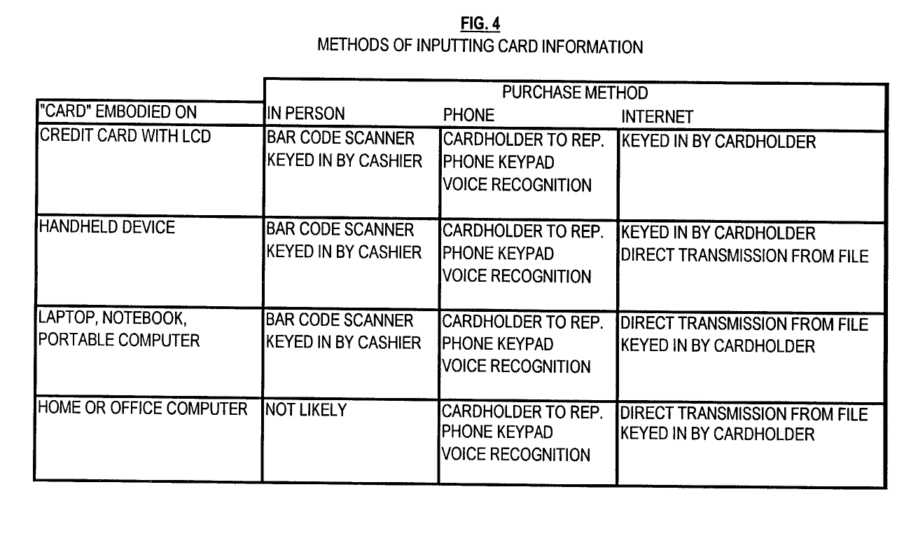

FIG. 4 is a chart showing methods of inputting information from the card for various purchase methods and types of cards. Such information might include: card number, account number, cardholder name(s), expiration date, usage restriction information, date according to the card's clock, time according to the card's clock, number of times the card has been used, and an encrypted code related to such information.

As can be seen from FIG. 4, the “card” may be embodied on: a card with a display, such as an LCD; a handheld computing device, such as a Palm Pilot or cellphone; a laptop, notebook, or other personal computer; or a home or office computer.

It is to be understood that the “cashier” listed in FIG. 4 can also be a clerk, waiter, salesperson, or anyone else capable of accepting an in person transactions, and that the “rep” can also be a telemarketer, salesperson, or anyone else capable of accepting a phone transaction.

Drawing of Exemplary Card

FIG. 5 is a detailed drawing at 2X scale of an exemplary credit card, debit card, ATM card or identification card which uses a PIN number to access the card. The keypad at the top of the card is used for inputting the PIN number and can be replaced with a voice recognition unit, a fingerprint sensor, a retinal scanner, or any other method of confirming the identity of the user.

The first 16 digits of the first row of bar codes contains the card number and the last four contain the expiration date. The second row of bar codes contains the date and time, in this case 06/08/2003 at 09:43:02 a.m., and an encrypted code which changes with each use. At the bottom of the card is the cardholder name and issuer name.

It is not necessary to display any information permanently on the card. However, since many individuals may carry more than one card and different individuals will have similar cards, displaying some information permanently on the card is usually desirable. Of course, cards can be printed with various colors, patterns, or designs which do not directly convey specific information but allow a user to easily find the card in their purse or wallet.

As mentioned above regarding step 201, it is also possible to create cards with no access control mechanism. In that case, control of access to the card is similar to current plastic credit cards. Many variations can be implemented for size, placement of elements of the card, the method of displaying a changeable bar code, and the method of accessing the card.

Second Embodiment for Identification Cards and Security Access

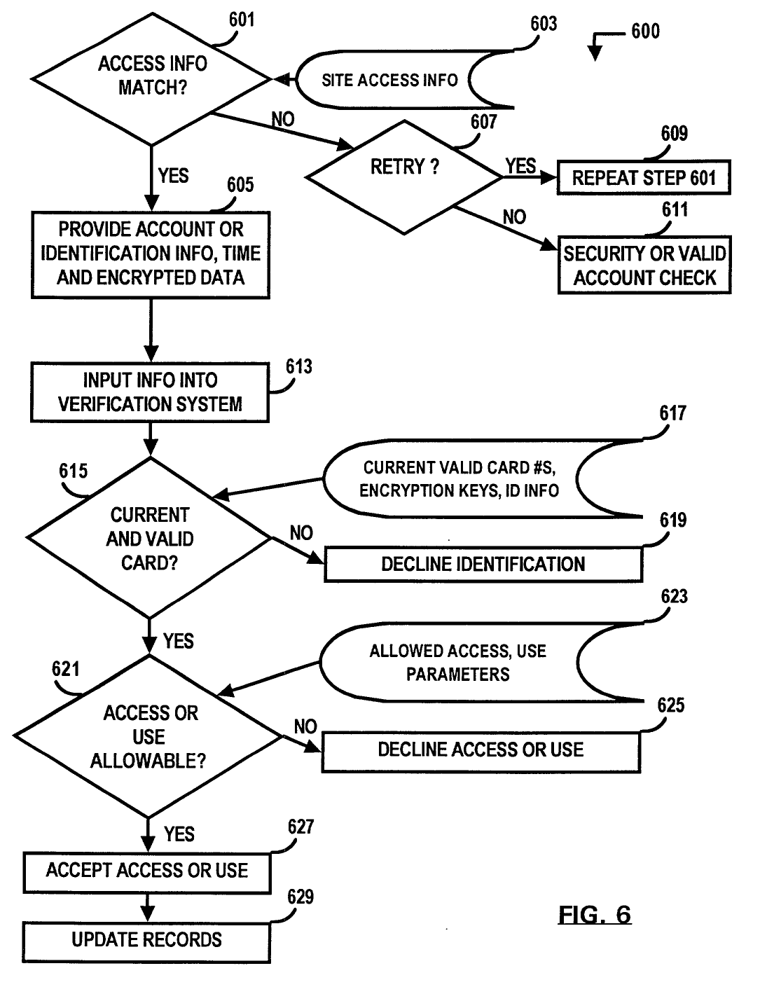

FIG. 6 is a functional flowchart showing usage of an identification card. In order to access the card and attempt a transaction, card access information 603 is provided by the user and compared with access information on the card itself to determine if both sets of information match 601. Card access information can come in many forms. For example, access information might involve a PIN number, a password, a fingerprint, voice activation, a retinal image, or an old-fashioned metal key. For high-security applications, multiple types of access info might be required on the same card, such as both voice activation and a PIN number.

If the access information does not match at 601, a “no” advances to 607 where a decision is made regarding retrying providing access information for the card. If the user would like to retry accessing the card, a “yes” advances to 609 and allows the user to retry providing card access information 601. If there is concern about whether an improper person is attempting to access the card, concern about whether the card is valid, or concerns about whether the card may be an attempted copy or counterfeit, a “no” advances to 611, where a security or valid card check is performed.

If card access information 601 does match, the card itself provides information 605 which may include: card number, access level, access time restrictions, account number, cardholder name(s), expiration date, usage restriction information, date according to the card's clock, time according to the card's clock, number of times the card has been used, and an encrypted code related to such information.

The card itself can provide information 605 in a variety of ways. Several different methods are shown in FIG. 3. The “card” can even be a program on a handheld computing device or a computer. One preferential embodiment is a card of similar size to a current credit card where information is displayed on a liquid crystal display (LCD), a detail drawing of which is shown in FIG. 5. This LCD can display data in a form directly readable by humans and by bar code scanners.

The information on the card is input into a local verification system or transmitted to a remote verification system 613. An example of a local verification system would be the security desk for access to an office building. Examples of remote verification systems might be the Social Security Administration verifying that a Social Security Card is valid, a State verifying that a driver's license is valid, a university verifying student identification to access a computer center, and a gym verifying a membership card.

Information input into the verification system 613 is checked to see if the card is current and valid 615, using a database including information such as: current valid card numbers, encryption keys, or identification information. If the card is not valid, a “no” at 615 will cause the verification system to decline the identification 619.

If the card is current and valid, a “yes” causes the verification system to determine if the requested access is allowable 621. Such access might be restricted by time, facility, use, etc. If the access is not allowable, the access is declined 625. If the access is allowable, the verification system accepts the transaction 627 and makes any necessary updates in records 629.

Virtually any characteristic of a smart card used for security or access can be integrated into cards with encryption-based fraud protection.

Third Embodiment for Internet or Local Area Network Access

A similar mechanism to encryption-based fraud protection for credit cards can be used for security on internet logins or internet financial transactions. It works very well if the user always works from the same computer or the same few computers. Such a login method will prevent the interception of passwords in transit. Passwords would have to be stolen by accessing the encryption program on the computer. The encryption program can also be external to the computer. It can be stored on a CD, DVD, floppy disk, USB device, or any other item which allows data to be read by the computer.

The advantage of using encryption-based fraud protection for internet logins or internet financial transactions is that critical access or authorization information cannot be intercepted in internet transmissions. For example, if a password allows access to an internet account with a pharmacy and the password and account information are intercepted, someone might be able to get a prescription for a controlled substance delivered to an addict's address instead of being delivered to the person for whom it is prescribed. Online banking, online brokerage, and online merchants will all derive benefits from additional security of logins and transaction authorization. If information sent to validate access is only useful one time, many forms of internet theft, fraud, invasion of privacy, and harassment disappear. Many forms of internet fraud involve breaking into databases of credit card information. If additional data beyond the credit card number is required for each new transaction, accessing large databases of credit card numbers is much less productive for thieves.

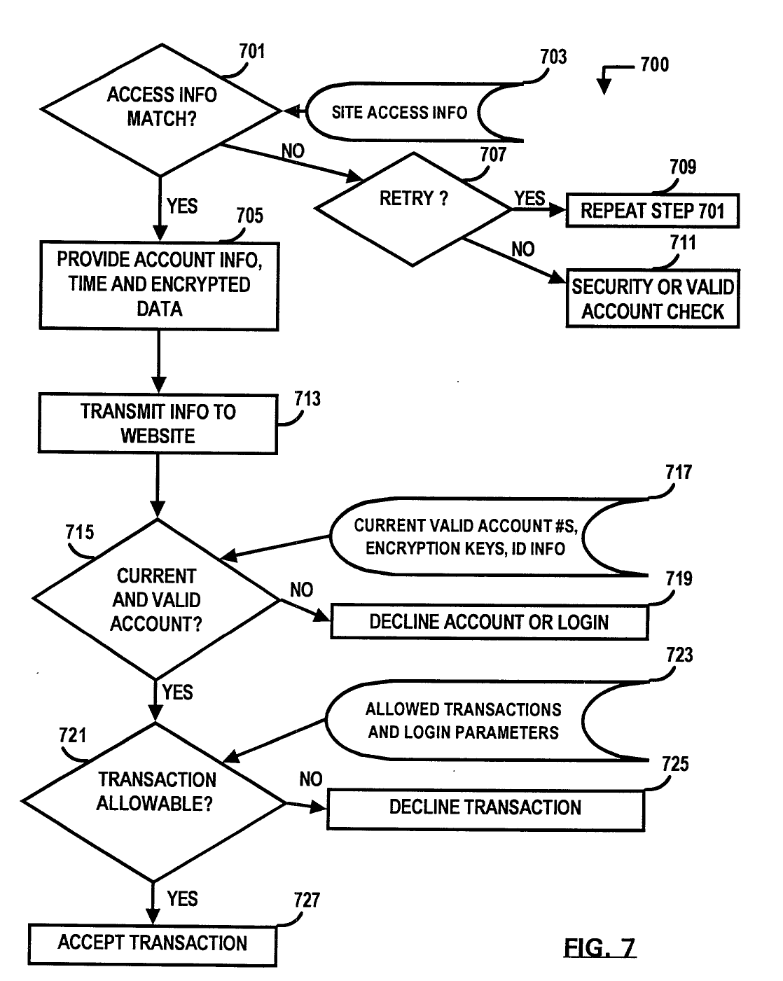

FIG. 7 is a functional flowchart showing usage of an internet access program located on a computer accessible to the user. The program functions in many ways like the encryption-based card described in FIG. 2.

In order to access the program and attempt a login or transaction, access information 703 is provided by the user's computer and compared with access information on a website or at an authorization center to determine if both sets of information match 701. Access information can come in many forms. For example, access information might involve a PIN number, a password, a fingerprint, voice activation, a retinal image, or an old-fashioned metal key. For high-security applications, multiple types of access info might be required on the same card, such as both voice activation and a PIN number.

If the access information does not match at 701, a “no” advances to 707 where a decision is made regarding retrying providing access information from the computer. If the user would like to retry access, a “yes” advances to 709 and allows the user to retry providing computer access information 701. If there is concern about whether an improper person is attempting to use the computer, concern about whether the card-emulation program is valid, or concerns about whether the program may be an attempted copy or counterfeit, a “no” advances to 711, where a security or valid program check is performed.

If card access information 701 does match, the computer program provides information 705 which may include: membership number, access level, access time restrictions, account number, cardholder name(s), expiration date, usage restriction information, date according to the card's clock, time according to the card's clock, number of times the card has been used, and an encrypted code related to such information.

The information provided by the computer program is transmitted to the website 713. Information transmitted to the website 713 is checked to see if the card is program is current and valid 715, using a database including information such as: current valid membership numbers, encryption keys, or identification information. If the program is not current or valid, a “no” at 715 will cause the website to decline the identification 719.

If the program provides information which is current and valid, a “yes” causes the verification system to determine if the requested access is allowable 721. Such access might be restricted by time, website, authorization level, etc. If the access is not allowable, the access is declined 725. If the access is allowable, the website accepts the transaction 733.

The process in FIG. 7 can also be used for authorization of software which needs to be activated or reactivated for use. In addition to one-time purchase or licensing, frequently software is leased or otherwise needs to be renewed. The access information 703 becomes access info for use of one or more software programs. The test at 715 becomes a test to see if the user has a current and valid account or authorization to use the software. The “transaction allowable” decision at 721 relates to a transaction authorizing use or continued use of the software. Since the process involves encrypted keys which activate the software, it is difficult for hackers to circumvent the authorization process.

Uses In Lower Security Situations

There are some applications of the technology which do not require high security. Since the same device can accommodate multiple cards or accounts, many people will have a mixture of high security, low security, and even no security cards embodied on one device. For example, a user might have: a Visa credit card, for which high security is very desirable; a parking garage entry card, for which a lower level of security might be sufficient; and a Ralph's Grocery discount card, which may work well with no encryption or access restrictions.

The discount card is a case where neither the cardholder or the merchant would lose money if a card was copied or used by someone other than the cardholder; someone fraudulently using such a discount card would still pay for his own groceries, just at discounted prices. At some stores, customers often use the discount cards of other customers they have never met but happen to be shopping at the same time, with the happy consent of the customer who is the cardholder, and the clerk. In these settings, there is little or no need to have the account number change from one transaction to the next. It is still advantageous to embody this card on the same device as higher security applications. The user can have cards of various security levels in one place, just as most people currently carry plastic cards of various security levels in the same wallet.

Methods of Accommodating Recurring Charges

There will be situations where a cardholder wishes to make recurring charges, often of the same or similar amounts at regular intervals. Examples are a cardholder who chooses to pay his phone bill each month via credit card and a cardholder who makes his car payment via a debit card each month. Much of this matter will be familiar to those skilled in the art of automatic payments. The major difference arises from having an account number specific to a merchant. This merchant-specific account number can potentially be restricted in many ways, including: time of use, amount per transaction, maximum amount per transaction, number of transactions, or total dollar value of all transactions.

Similarly, a cardholder may wish to make charges of irregular amount or frequency with the same merchant. An example would be someone who purchases books from Amazon. com at irregular intervals for varying amounts. As with recurring charges, criminals attempting to fraudulently use the merchant-specific card number will find their opportunities quite restricted. In the Amazon.com example, the criminal might be restricted to charges of $100 or less, and only at that merchant. Of course, the cardholder could simply decide to manually provide a different number each time for the highest level of security.

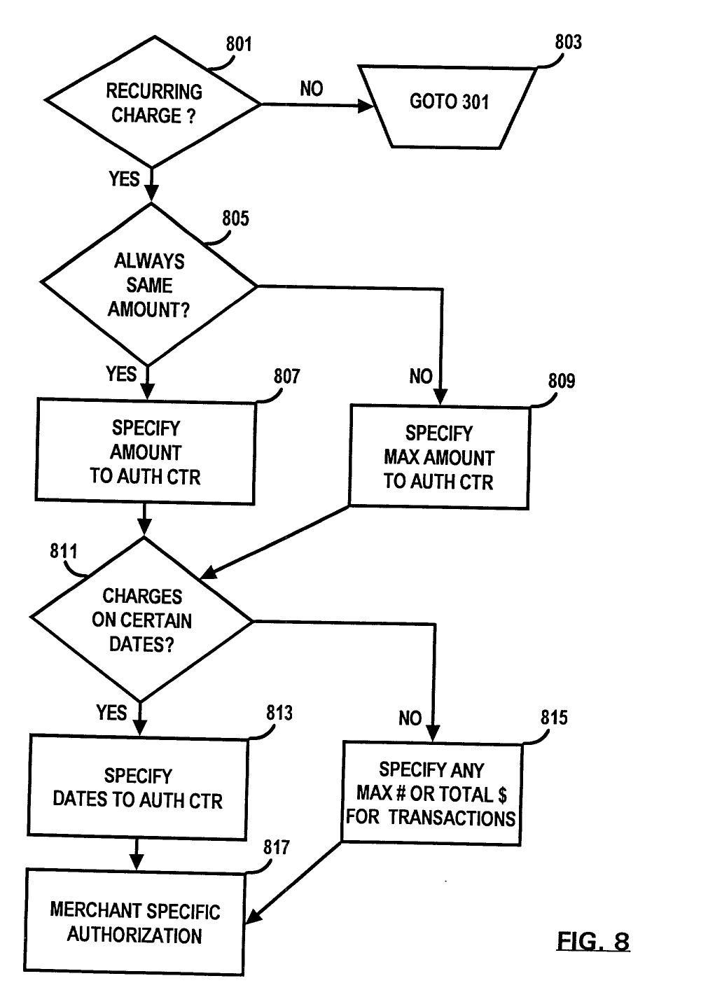

FIG. 8 is a functional flowchart showing how to establish and use a recurring account number specific to a single merchant. 801 asks whether there will be recurring charges with the same merchant. If the answer is no, 803 advances to 301 for nonrecurring charges. If the answer is yes, advance to 805. At 805, if the charges will always be for exactly the same amount, a yes advances to 807, where the exact amount of the charge is specified. Examples where 807 is appropriate are an automatic car or mortgage payment of uniform amount each month. A no at 805 advances to 809, where the maximum amount to be authorized for an individual charge is specified. Examples where 809 is appropriate are monthly phone or utility bills of varying amounts, but for which a reasonable maximum can be estimated. Both 807 and 809 advance to 811. If charges will be made on specified dates, such as the fifteenth of the month, or the first business day of the month, such restrictions, a yes advances to 813. If charges will not be made at predictable times, a no advances to 815, where any restrictions on the number of charges or the total dollar value of transactions are specified. Both 813 and 815 advance to 817, where a merchant-specific account number is created, subject to whatever conditions are specified in steps 805-815.

Methods of Accepting Deposits

An interesting benefit appears when the approval process allows card numbers to vary for the same account. It is now possible to designate an unchanging number for each account which only works for deposits to that account. Unlike providing an account number which can also be used for purchases, a deposit-only number has minimal potential for abuse by anyone except the cardholder. For individuals, this allows the replacement of many personal checks written to the cardholder. For example, Bob helps Ted build a new garage. Currently, Ted would probably write Bob a paper check, or perhaps pay cash. With the Encrypted Virtual Card, Ted could make a payment from Ted's account using Bob's deposit-only account number. Thus, no paper transaction is necessary. The transfer of funds is almost immediate and Bob does not have to worry about a closed account, a stop payment order, or insufficient funds in Ted's checking account. Having Bob's deposit-only account number does not provide Ted with the ability to make any charges on Bob's account. The deposit only account number can also be reusable by different persons at different times, by anyone who wants to send money to Bob.

Functionally, the deposit-only account number works similarly to current merchant identification numbers for most purchases. There is no limit on the deposit size for the account into which the money is being deposited. The only necessary verifications relate to assuring that the money is deposited in the correct account.

If the person or entity receiving the deposit is providing information, the method used for charges in FIG. 2 can be easily adapted by replacing Purchase Information 213, with Deposit Information and by replacing Merchant Information 217 with Deposit-only Account Information.

Methods of Installing Software

Currently, the typical method of shipping a new card is to send a plastic card via regular mail. In fact, many persons find their mailbox infested with unsolicited credit card offers which include plastic credit cards. These cards have various activation processes. Sometimes, credit card fraud occurs for credit cards which the intended owner never saw; someone intercepted the card offer, fraudulently activated an account and used the card.

At one time, personal computers were shipped with minimal amounts of software installed. The user went through the laborious task of installing much of the software, and making sure various settings matched their computer. Many computers are now shipped with much more software than a user is expected to use. A common example is a computer shipped with software for various internet service providers (ISPs). A user would not be expected to use all of the ISPs whose software was installed on a new computer, but the software is there for the user's convenience. Similarly, it is easy to include a copy of the encrypted card software on all devices of a particular type.

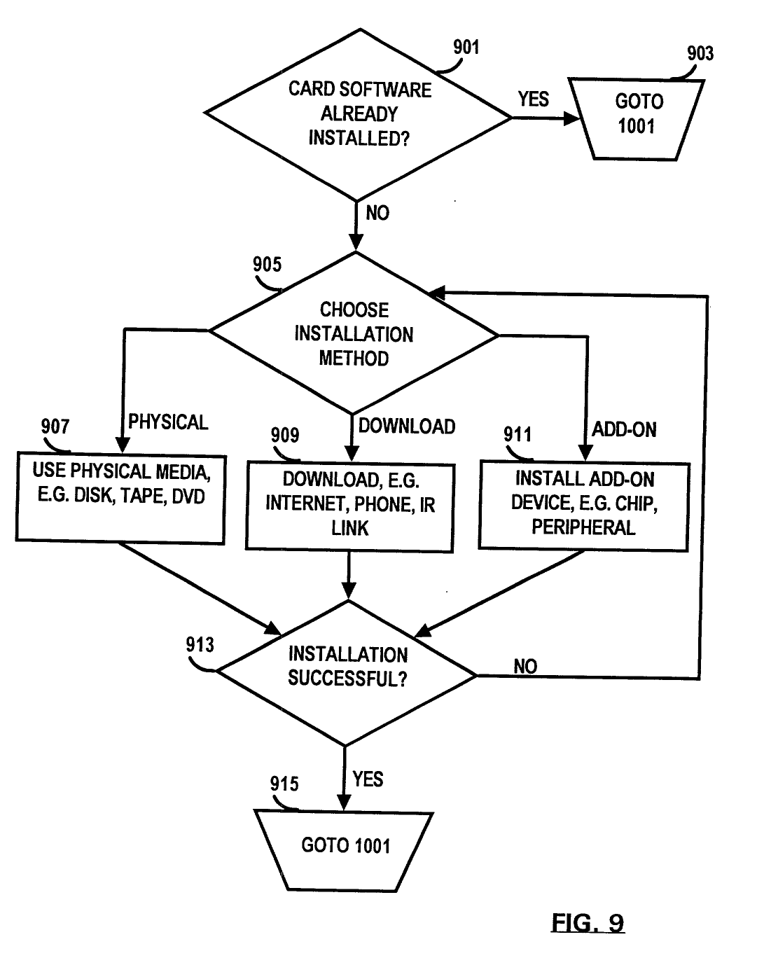

Because the Fraud Resistant Credit Card can be embodied on devices used for other purposes, two common methods of installing software will be downloading software and buying a device with the software already installed. A wide variety of methods for installing the software are contemplated. A representative variety of installation methods are shown in FIG. 9.

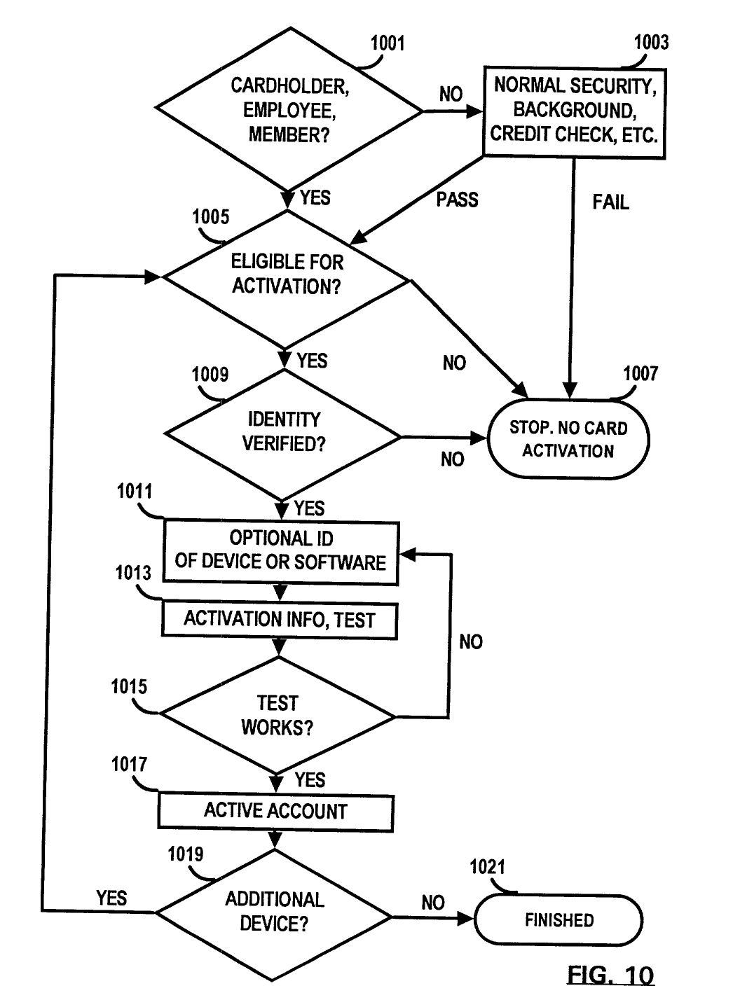

At 901 a check is performed to see if card software is already installed on the device. If yes, 903 refers the cardholder to 1001 on FIG. 10 to activate the card software for a particular account. If card software is not yet installed on the device a no advances to 905. At 905 an installation method is chosen. A user may have multiple choices for the means of installation, or may have only one.

Virtually any method of installing software or add-on hardware for a particular device can be used for installing encrypted card software; FIG. 9 includes a representative selection of such methods. However, new methods of installation are expected to arise. New installation methods may be used without impairing the functioning or usefulness of software once installed. If the installation method involves shipping information on physical media (e.g., floppy disk, CD, DVD, or tape), said physical media is used for installation at 907.

If the installation method selected at 905 is downloading (e.g., internet, phone, infrared link, or cable), said download occurs at 909. A third method of installation at 905 is using and add-on device. Any such add-on (e.g., chip, peripheral) is installed at 911. One interesting add-on is referred to as a “dongle”. Dongles are hardware devices typically used to assure that software being used on a device is properly licensed; dongles do not normally contain the entire software code for a program. Dongles might be used for encrypted cards in high-security applications where highly motivated, resourceful attempts would be made to circumvent software security. Intelligence and counterintelligence is one such application.

All methods of installation 907, 909 and 911 advance to a check to verify that installation is successful 913. If installation is successful, a yes advances to card activation at 1001 of FIG. 10. If installation is not successful, a no advances back to 905, where another attempt at installation is made.

Methods of Activating Cards

Having card software installed does not yet give the user the ability to do financial transactions, use the card for identification, or use the card obtain access. This is similar to having email software installed but not yet having an email account. Activating a card is described in FIG. 10.

Having a card which is very difficult to forge or impersonate does not mean that the cardholder will pay his bills on time or make a good employee. At 1001, a check is performed to see if the user requesting activation is already a cardholder, employee, member. If no, the user goes through a normal security or background check relating to the card's intended use apply for a credit card, fill out employment papers, become a member of a club. If the user fails said check at 1003, no card is activated, 1007.

If the user passes at 1003, proceed to 1005. A yes at 1001 also advances to 1005. There may be separate fees or eligibility requirements for using an encrypted card. Among these may requirements relating to the user, the device, the version of software on the device, or the device's place of use. If the user is not eligible to activate his device, a no advances to 1007 and no card is activated. If the user is eligible for activation at 1005 a yes advances to 1009, where the user's identity is verified. If the user's identity cannot be verified to the satisfaction of the card issuer, no card is activated 1007. If the user's identity is verified, a yes advances to 1011.

It is possible to identify the individual device or software installation. Such identification may prove useful in case of device theft or problems with software or hardware. In some systems, this identification information may be used for confirming identity of the cardholder. After any identification of the device or software is complete at 1011, activation information is provided and a test is performed to check proper operation at 1013. Activation information can be delivered in many ways, similarly to installation methods in FIG. 10. Activation info and/or testing may also be provided by live humans, for example, in person at the issuing bank.

If the test at 1015 works, a yes advances to having an active account at 1017. If the test fails, a no returns back to 1011 to make another attempt at activating the device.

At 1019, a check is performed to see if the user wishes to activate any additional devices. For example, this might be the case for a user with a home pc and a portable Palm unit. If yes, advance to 1005 and repeat the activation process for the new device. If no, activation for all devices is complete and the activation process is finished at 1021.

There is no obstacle to embodying multiple cards or accounts on the same device. For example, the same software which functions as a Visa credit card can also function as a Bank of America debit card, a Gold's Gym membership card, and a Library Tower building access card. Each card can have different characteristics, but benefit from similar security and operation on a single device.

It is also possible to ship the device hosting the card already activated, but requires care in assuring delivery to the proper person. If users typically use multiple cards on the same device, most activations will likely be made when the user is already in possession of the device. Because the business arising from certain types of cards will be quite profitable, some card issuers may subsidize the cost of new devices, perhaps even giving them away. Potential examples include: employers whose employees have expense accounts, credit card issuers, and cellular phone companies.

Methods of Deactivating Cards

In the same way that many current technology plastic credit cards and membership cards have an expiration date, encrypted cards can be programmed with scheduled expiration dates. There will also be instances where unscheduled deactivation is desirable. Unscheduled deactivation might occur for a variety of reasons, including but not limited to: device lost or stolen, suspected unauthorized use, new replacement device purchased, cardholder deactivated, employee leaves company, membership revoked, access privileges revoked, device damaged or not operating, device not operating properly, or device unable to run new version of software.

An advantage of the encrypted card is that account numbers can remain intact even when a device is stolen. For example, it is possible to simply activate the same accounts by providing encryption keys for a new device. In cases where the user is replacing an old device with a new one, encryption keys can remain the same, as long as deactivation of the old device is certain. Prudence would normally lead a card issuer to provide a new key for each new device, to avoid the chance that an old device was not deactivated and might be used fraudulently or maliciously.

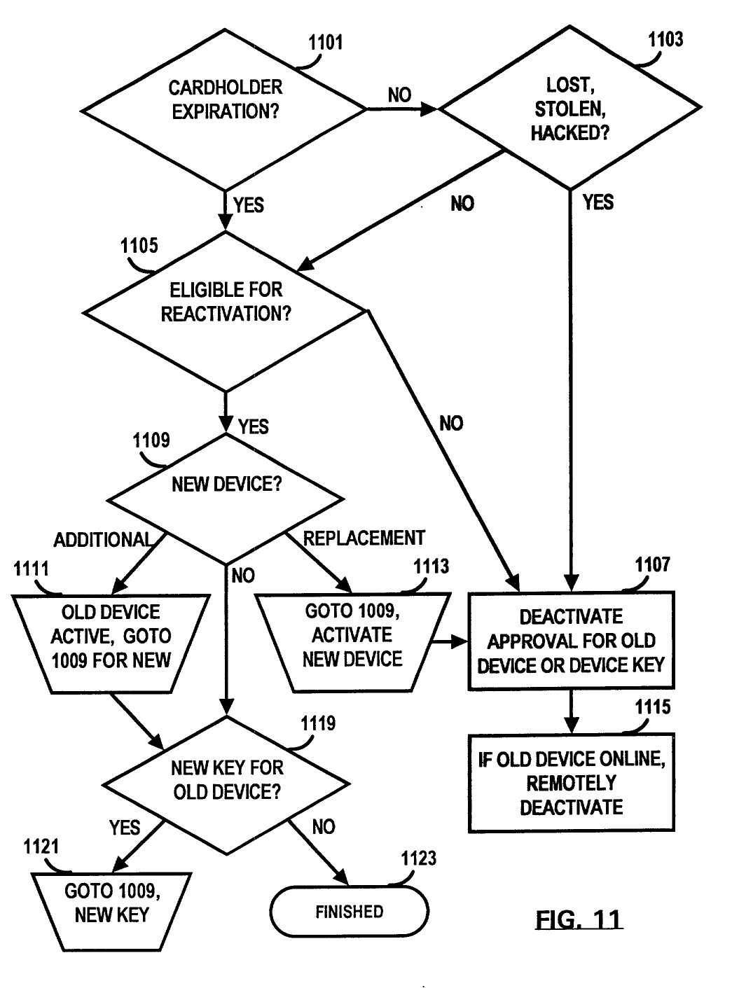

FIG. 11 is a functional flowchart showing methods of deactivating old or missing cards.

The most common form of deactivation will probably be cardholder's scheduled expiration. In the same way that plastic credit or debit cards must be replaced periodically, encrypted cards may have scheduled expirations and/or renewals. At 1101, if the cardholder account is expiring, a yes proceeds to 1105. Examples of expiration may include: scheduled expiration of a credit or debit card, cardholder voluntarily requesting a credit card be cancelled before normal expiration, unscheduled expiration of building access when an employee leaves a job, scheduled expiration of a driver's license at renewal, unscheduled expiration of driver's license due to revocation for drunk driving, and expiration of an annual video rental club card.

At 1105 a check is made to see if the cardholder is eligible for reactivation. If the cardholder is eligible, a yes advances to 1109. A no advances to 1107.

If this is not an expiration at 1101, a no advances to 1103, where a check is performed to see if there are problems such as: missing device, stolen device, suspected or confirmed hacking, or unauthorized use without theft of device. If there are no problems relating to unauthorized use or missing devices at 1103, a no advances to 1105. If there are problems relating to unauthorized use or missing devices, a yes advances to 1107.

At 1107, the card is deactivated. This can be done by invalidating the current encryption key used by the authorization center. If the old card is a plastic or smartcard, the device may be destroyed, returned to the authorization center, or the account number on that card deactivated. Similar transactions to those which worked before deactivation will not work afterward, if attempted on the same account on the same device. If the device is still in the user's possession, the user can also take additional steps to assure inactivation, such as turning that account off at the device itself Normally. disabling one account has no effect on other accounts on the same device. After these deactivation steps proceed to 1115.

1115 is not required, but it is possible to take an additional step of deactivating an account on the device remotely. This can be accomplished via phone, cellular, wireless, email, page, or any other means of communication of which the device is capable. At 1115, it is also possible to have all cards on the device, or the entire device, deactivated remotely with one action. This might be a common step in cases where the device has been stolen. Deactivating all accounts might not only prevent unauthorized financial transactions, but also impersonation, such as accessing the rightful owner's office or home.

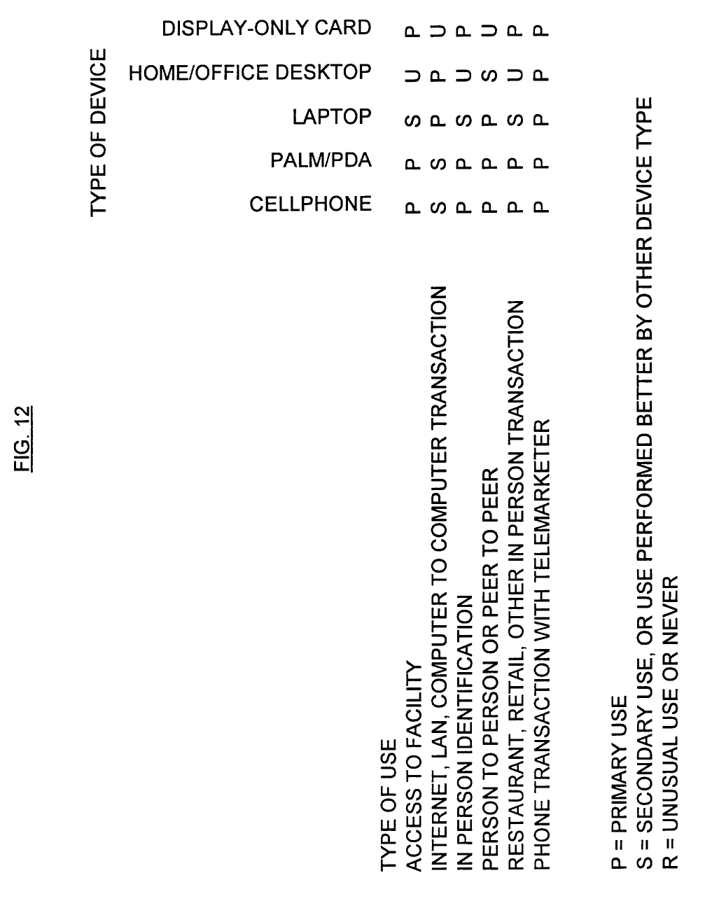

At 1109, accounts eligible for reactivation are checked to see if the user would like to use a new device. For an additional device advance to 1111. A user might want the same account on multiple devices, as described below in FIG. 12. An additional device can be authorized in a manner similar to the current device. To activate the additional device, the process continues at 1009 and a check is made to see if the old device should get a new encryption key 1119.

If no new device is being activated, a no at 1109 advances to 1119. It may be desirable to provide a new key to the current device at 1119. If yes at 1119, advance to 1121. At 1121 a new key is provided to the software using the activation process at 1009. If no, the process is finished at 1123.

If there will be a new replacement device, advance from 1109 to 1113. 1113 activates a new device starting at 1009 and advances to 1107 to deactivate the old device.

Methods of Upgrading Software

One of the major advantages of the Fraud Resistant Credit Card Using Encryption on a device which is also used for other purposes is ease of upgrade. For traditional plastic credit cards and smartcards, usually new cards must be manufactured and issued to implement the change or upgrade. This is similar to the manner in which pc software was sold at retail in shrink-wrapped packaging or delivered via mail. In either case, a physical delivery was made for the change or upgrade.

Over time, technology will create new devices, new methods of transmitting data, new methods of attempting fraud, and new steps in security. It is common for users to replace computing devices periodically. Users of personal digital assistant (PDAs, such as Palm, Visor, or Blackberry), cellphones, smartphones, laptop computers, desktop computers, and other electronic devices often replace or upgrade such devices every few years. Thus, it is likely that hardware upgrades will be common. Similarly, new hardware often incorporates new software.

The first upgrade for many customers will be from a plastic card or prior technology smartcard. One method of performing this upgrade is to follow the process in FIGS. 9, 10 and 11, where the cardholder's old plastic card or smartcard is the old device.

Technically, nothing prevents allowing the cardholder and authorization center from agreeing to keep a plastic card active for the same account where the Fraud Resistant Credit Card Using Encryption is also active. While the Fraud Resistant Credit Card Using Encryption provides greatly enhanced security, ease of operation, and compatibility with the great majority of merchant equipment, some cardholders or card issuers may prefer to have both types of card on a single account for a period of time. This would guarantee backward compatibility for the cardholder. However, the user should be apprised that the security on the old technology card is not as good and frequent use of the old technology card will result in similar risks to not having the Fraud Resistant Credit Card Using Encryption at all. Of course, nothing prevents a user from having a plastic card from one issuer and an encrypted card from another issuer.

Note that the process of deactivating old devices and activating new ones is similar in nature to providing new plastic cards or special-purpose smartcards. However, in this case, the same device embodies multiple cards. In many cases, the users or a third party will provide the new device and/or software. This relieves financial institutions of the burden of securely shipping and activating the cards themselves. For a cardholder, it provides a single, consistent place and manner of operation for an assortment of cards and accounts.

Using Multiple Devices for Same Account

One major advantage of the encrypted card is that it can be embodied on multiple devices simultaneously. When used properly, this can lead to maximum convenience with no loss of security. Various combinations of multiple devices or devices of the same type can be used. A chart showing advantages of cards embodied on different devices is in FIG. 12.

A representative selection of devices is shown, though new devices will no doubt arise. Though some devices can perform for all types of uses listed, current devices have at least one use for which another device is substantially better. This is one of the primary reasons for having multiple devices for the same account. For example, a Palm/PDA device is quite good for many uses, but a laptop or desktop pc is typically more useful for browsing internet content and making purchases on the web. Conversely, a desktop pc is good for may uses, but is not sufficiently portable to be used efficiently for in person transactions at retail.

The display-only card described in FIG. 2 is unable to communicate via phone or peripheral to take input data, thus it would not work by itself for internet purchases; the user of a display-only card would have to obtain information from the card and use that information in conjunction with another device when using the internet. If a display-only card is used similarly to plastic cards, one account per card, a user could have as many display-only encrypted cards as they currently have plastic cards in their wallet.

Many reasons for having multiple plastic cards on the same account will also apply to encrypted cards regardless of the device type, such as a husband and wife on the same credit card account.

Different devices may have different encryption keys for the same account. This may be due to differing software or hardware between devices, to aid in diagnosing any problems on the account, or most likely to allow deactivation of one key at a time if one device is stolen or replaced.

Deposit and Payment Capability on Same Device, Communication

Many devices suitable for use as an encrypted card can read bar code displays of other suitable devices, text displayed on other devices, or can communicate with other devices via electronic connections such as phone, wireless, radio, or infrared. With suitable software and/or peripherals, the same unit can act in complimentary capacities: as credit card or merchant credit card terminal, as payment device or deposit device, as identification or identification screening device.

When used for payment, the device used for payment can communicate with the device used to receive payment. For example, the merchant's cash register could send the entire receipt to the customer's device. Thus, the customer could know not only that she spent $112.53 at The Corner Grocery, but also what items she bought.

When used for identification, the device carried by the user could communicate with the security system(s) to track what structures were entered and when. This is an interesting case where an unchanging code provided by the building security system, or even a permanently printed barcode would work as the data collected by the device. The card knows when ID was requested, it only needs to know where. There are no dollar amounts to be tracked.

Portable read devices will be useful for many groups, likely including: police officers (e.g., verifying drivers' licenses), waiters (meal payment in one trip to the table instead of two with a fixed device), paramedics (e.g., medical history, identification, insurance).

Associated Software

Embodying the encrypted card on a computing device provides numerous opportunities for using a card with other programs or using transaction data in other programs. Examples include using the transaction data to automatically send data to expense account, electronic checkbook, spreadsheet, tax or accounting software. Another example is to provide data from calendar software, or data received from other sources, to prompt for the user to individually approve charges which occur at times known in advance, as an alternative to the process in FIG. 8. Such other sources might include creditors, utility companies or even courts requiring child support payments.

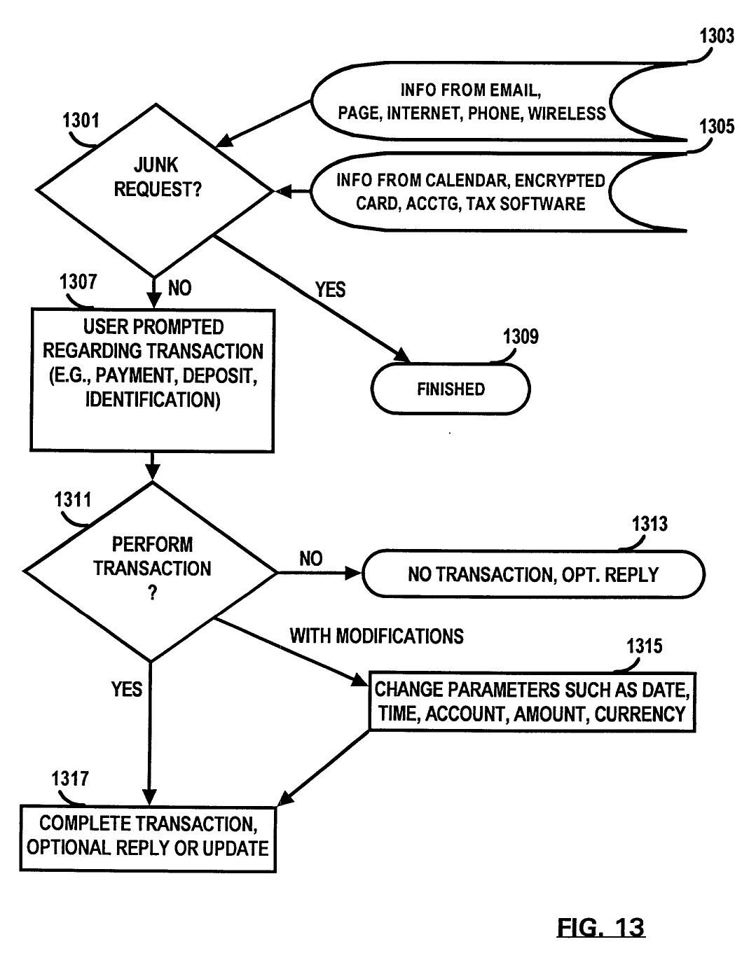

Prompted transactions are outlined in FIG. 13. Prompted transactions come from two types of sources: outside of the device on which the card resides and from software running on the device itself Outside sources of information 1303 include information arriving via, for example: cable, phone, internet, email, paging, wireless, infrared, and even traditional paper mail or floppy disks delivered by the postal service. Exemplary sources of information from software on the device itself, 1305 include: the encrypted card software itself, a calendar program on the device, tax software on the device, accounting software on the device, and financial planning software on the device.

The information from outside 1303 and/or inside 1305 the device prompt the user regarding a potential transaction. These transactions are not limited to financial transactions. For example, if a video rental card is embodied on the device, the user might be prompted to return a late video or find his borrowing privileges suspended.

It is also possible that the prompt for a transaction is from an entity which the user has no affiliation or prior business, such as solicitation for a charitable donation. These could quickly become the portable wireless equivalent of paper junk mail, telemarketer solicitations, or email spam. Software will probably evolve to block most junk requests. Thus, either the user, the software, or both will work to evaluate whether a prompt for a transaction will be accepted at 1301. For junk requests, a no advances to 1309, where the process terminates and no transaction is performed. A yes advances to 1307, where the user is prompted regarding the transaction. Next a decision is made about whether to perform the transaction 1311. If yes, the user attempts to authorize and complete the transaction at 1317. There is an optional reply or update to various parties and/or software regarding the completed transaction at 1317. For example, if the transaction was prompted by a calendar program on the device, the calendar program might be advised that the task is complete.

For a wide variety of reasons, the user might decide not to complete the prompted transaction. For example, a user may be about to pay a bill in cash, be on his way to return the late video, or have insufficient funds at the moment. A no terminates the process at 1313. There is also an optional reply or update to the requesting party or software.

In some cases, the user may wish to perform the transaction with modifications. At 1315 any transaction parameter(s) can be changed and the modified prompted transaction completed. Examples of changes include: amount, time, date, account used, and currency in which transaction occurs. With these modifications, the transaction is completed at 1317.

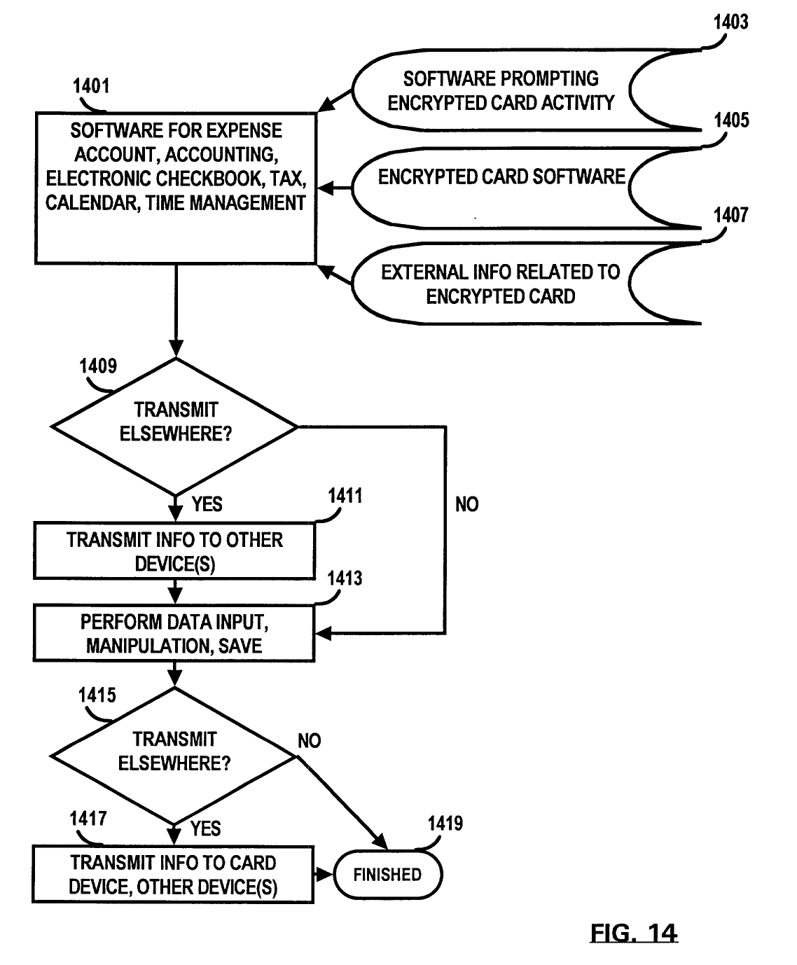

Usage of information from completed transactions by other software is outlined in FIG. 14. Embodying the card on the same device as a checkbook program, account program, spreadsheet, or accounting software enables additional abilities to identify incorrect or fraudulent charges. It also reduces the amount of effort required to use many pieces of software and reduces input errors.

One straightforward application takes information from the encrypted card and uses it for expense accounts. Many highly paid executives still spend what would otherwise be productive or billable hours keying in information from paper receipts and statements to do regular expense accounts. With both expense account and card on the same device, it is very easy to classify an expense as soon as a charge is made, without having to key in data from a paper receipt, even for taxi fare or a dinner bill. Currently, no known system on a portable computing device can pay for such expenses using an account number which can vary and automatically update expense account software.

Similarly, data can automatically be transferred to other financial software, such as tax or accounting software. Nonfinancial data from encrypted card usage can be transferred to other programs on the same device. For example, time of entry and exit from the office when a card is used for building access. A user could track their own work hours independently.

At 1401 software such as expense account, accounting, electronic checkbook, spreadsheet, tax, calendar, or time management software accepts input. This input may come from software which prompts encrypted card activity 1403, the encrypted card software itself 1405, or external information 1407. In the case of an expense account program, the software prompting card activity 1403 might be a calendar program which also prompts an executive to fill out his monthly expense account. The encrypted card software 1405 may provide much of the information required for the expense account. External information related to the card 1407 might include a monthly credit card statement.

The software 1401 checks to see whether to transmit information to other software or applications before performing any manipulation of the data at 1409. Such transmission might include making backup copies, or consolidating information from multiple devices or accounts. If yes, advance to 1411 to transmit information to one or more devices and then to 1413. If no at 1409, advance directly to 1413. After any data input, manipulation, or saving by one device at 1413, 1415 checks for a need to transmit info elsewhere. If yes, info is transferred 1417 and is then finished 1419. If no, the process is finished at 1425 without any transfer of data at 1417.

Image Display

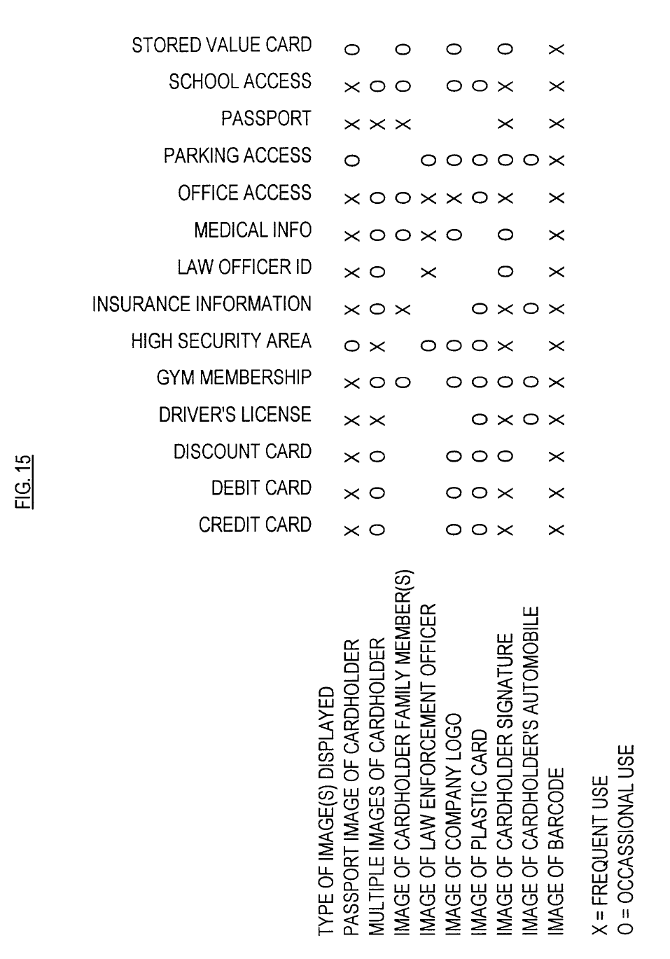

There are many cases where display of an image is desired as part of the identification or transaction process. For example, a user might have a passport-type photo which displays on the device at some point in the transaction. Other common images might include an image of a signature, of an original plastic card, or of barcoded information relating to items purchased. Various situations where these might be useful are described in FIG. 15.

Images of the cardholder will be common for identification. Many devices on which encrypted cards can be embodied are able to display much larger images, or many more images, than a typical driver's license or passport photo.

When used by law enforcement officers, these devices could track access to various facilities with great accuracy, prevent fraudulent access to facilities (e.g., evidence rooms), and make impersonation of officers very difficult. A badge number which changes daily, an image of the officer stored on the device, and a custom cover, wrapper, or coloring on the device would be far more secure than a simple gold badge with a name and unchanging badge number.

Many companies will issue devices to their employees, often with the company logo or colors permanently placed on the outside of the device or displayed on the device screen at some point during use. Similarly, identifying marks on the outside of the device relating to at least one card embodied on the device will aid in easy identification of similar devices and provide a form of advertising. One can easily envision palm devices or cellphones emblazoned with logos or colors from companies such as American Express (credit card), Blockbuster Video (video rental card), or AT&T (phone credit card), or Medic Alert (insurance card, see below).

As encrypted cards become more common, more and more people will have medical problems while in possession of the devices, in the same way that medical problems occur while people are in possession of their purses or wallets. Thus, providing medical information in a manner readily accessible to medical personnel could be of critical, or even lifesaving, importance. A picture of the device's owner would aid in making sure that the medical information indeed relates to the person being treated, and not for example, a family member who is in possession of the device.

Medical information and insurance information for a patient can be recorded in great depth on a portable unit. It can be displayed using text, pictures, bar codes, or any other means the screen is capable of displaying. Of course, the unit can also transfer said information in various manners to other electronic devices. The usefulness of the data can be increased with a distinctive marking on the unit, perhaps similar to Medic Alert markings. The distinctive marking will alert medical personnel that important medical or allergy information is on the unit.

Encryption Methods

There are a large number of methods of encryption and of verifying the identity of the source(s) of electronic data. These are well known to those skilled in the art of cryptography and computer security. A very large variety of these methods can be used with the Fraud Resistant Credit Card Using Encryption. A broad group of these methods work when the cardholder's device provides information which varies with each use in a manner known in advance by the Authorization Center.

The only requirements for the encrypted card system to function securely are that: 1) information from the cardholder's device can vary from one transaction to the next in a manner which is not easily guessed, and 2) only the authorization center knows in what way the information can vary and what information is required for a valid transaction.

In one method, the authorization center can provide information to be used for subsequent transactions to a cardholder periodically or on demand. For example, an authorization center could provide a group of 10 account numbers valid if used by the cardholder within 30 days. At that point, a new set of account numbers would be provided. While this method is functional, it requires some sort of communication from the authorization center to the cardholder before transactions. This step is not necessary if the cardholder has an encryption key which varies cardholder information from one transaction to the next in a way which the authorization center can confirm, but others cannot usefully copy or guess.

With high-level encryption, changing a single character in the unencrypted file produces a very different encrypted file. Thus, the variable information can be quite short. However, it should be long enough that valid encrypted files will not repeat, or will repeat very rarely in a manner which is difficult or impossible for thieves to predict.

Examples of sources for varying information which are easily implemented by an authorization center are: date of transaction, time of transaction, serial number of transactions, and a number taken in sequence from a random number table known only to the authorization center and the cardholder's device. These methods can be combined in various ways. For example, the cardholder's device could use the date of transaction and the number of transactions so far on that date. This would make information provided by the cardholder different with each transaction. In this case, it is also possible for the authorization center to calculate what information should be provided by that cardholder for the next transaction occurring on that day, if any. Being able to calculate the expected information in advance, but having that information expire at least once a day, provides good security and accommodates fast processing even in peak activity periods.

In order to enhance backward compatibility, the information can be encrypted in a manner that any current systems operating between the cardholder and the authorization center do not know or care if said information is encrypted. Such systems include a variety of point of sale systems of various vintages. Many point of sale terminals either can read barcodes (e.g., grocery bar code readers, usually intended for UPC barcodes), or accept peripherals which can read barcodes. These readers are capable of reading a barcode on a portable device in the same manner as a preprinted barcode.

To prevent confusion between cardholders of the same name (e.g., common names such as Tom Brown, Robert Jones, or Mary Johnson), it may be desirable to have a portion of the account number consistent from one charge to the next.

Together, the unencrypted and encrypted information can resemble traditional information on a plastic card: Cardholder Name, Account Number, and Expiration. However, the unencrypted portion of the information tells the authorization center who the cardholder is and the authorization center uses this to access a key applicable to that cardholder. Unless there is a security breach, the key should only be known to the authorization center or it's designees. The encrypted information tells whether this transaction is originating from the cardholder's device as expected. The information from the current charge will be useless for a subsequent fraudulent charge: the valid information will change.

Only a few digits in the card number need to be variable for good security against guessing valid information for a transaction. For example, four varying numeric digits would give 10,000 possible card numbers for an individual transaction. Four varying characters which include 26 alpha characters and 10 numeric characters provide 36ˆ 4 (1,679,616) possible card numbers. In such a system, one does not even theoretically “run out” of card numbers; they are reused on a very infrequent and unpredictable basis.

Typical credit card numbers are 15 or 16 digits. If four digits are used for encryption, the remaining 11 or 12 digits do not need to vary. With 12 numeric digits, there are still 100 billion unchanging possible card numbers, about 12 card numbers for each man, woman and child alive today. Thus, using four digits for encryption would still allow the use of a 12 digit card number uniquely identifying each cardholder, even if an authorization center used only card numbers (but not the name or expiration) for at least some transactions.

Note that this is an approach designed to fit within the constraints of a variety of systems and technology currently in widespread use. Many systems which would have other advantages over those contained in the current application demand expensive and time-consuming changes for the cardholder, merchants, or authorization centers. Note that the present invention could be used with only one cardholder and one authorization center; merchants would have no required changes in order to implement the system. Future implementations of the present invention may allow flexibility in other ways, such as longer card numbers or alphanumeric card numbers.

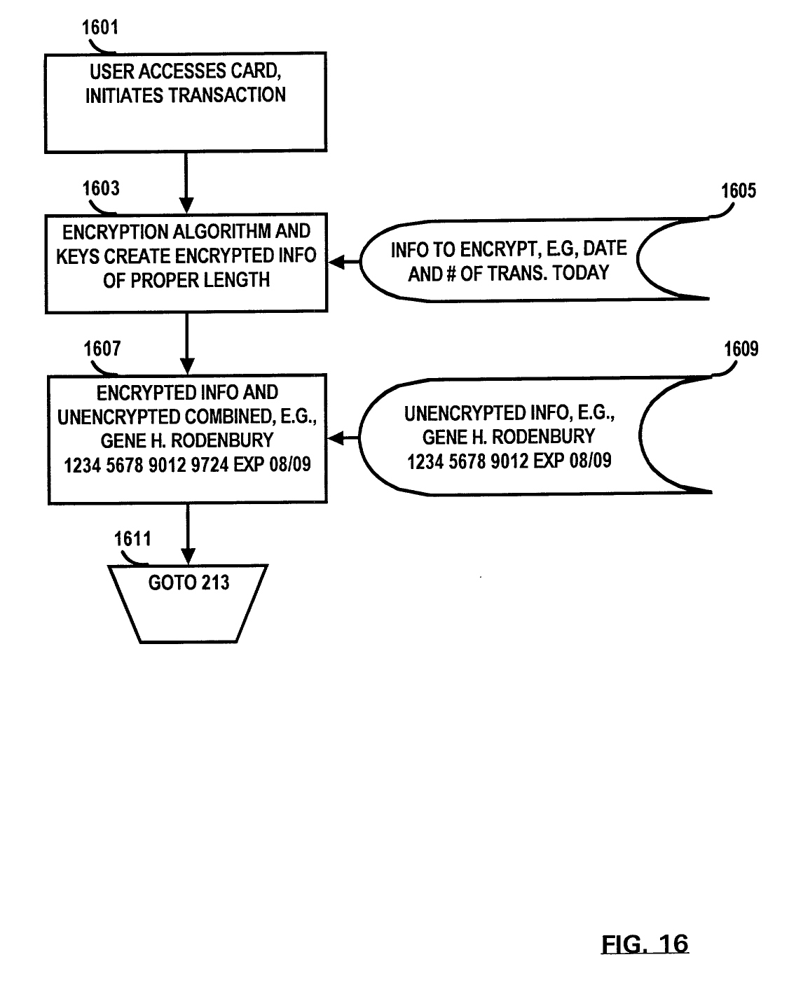

FIG. 16 is a functional flowchart showing an exemplary method of encryption which is useable with current point of sale systems. At 1601 the user accesses the card to initiate a transaction. As mentioned under FIG. 2, access information might involve a PIN number, a password, a fingerprint, voice activation, a retinal image, or an old-fashioned metal key. For high-security applications, multiple types of access info might be required on the same card, such as both voice activation and a PIN number.

After the user accesses the card, information to encrypt 1605 is input to an encryption algorithm 1603. The information to encrypt can come from a wide variety of sources; for example, the information to encrypt is the date and the number of transactions occurring so far today. Said algorithm 1603 produces and encrypted value of the proper length using software including the cardholder's key, for example, a 4 digit numeric code. At 1607 the encrypted value from 1603 is combined with unencrypted info 1609, for example, cardholder name, expiration date, and the first 12 digits of a 16 digit account number. The combined information appears to be the same as would be found on a traditional plastic credit card: cardholder name, expiration date, and a 16 digit “account number”. However, the last 4 digits of this account number vary in a way only the authorization center knows in advance. It is also possible to input the date and time into the encryption algorithm and create encrypted info which the authorization center does not know in advance. This demands some method of knowing the time on the cardholder's device. Synchronization and time zones make such a system more difficult to administer, but such a system may be appropriate for the highest security uses.

Encryption algorithms or keys may also vary in any fashion which is known or can be detected by the authorization center. A primitive example of encryption which varied from one day to the next was the German Enigma machine of World War II. Such systems are frustrating to code breakers, since determining the key for one message is of little help in anticipating the following days' codes.

Steps 1603-1609 are one example of providing account or card info and varying encrypted data, as in 205 of FIG. 2. From step 1607, 1611 advances to 213 of FIG. 2 to complete the transaction.

Note that any encryption performed with the encrypted card does not interfere with other encryption schemes, such as those used in communicating or saving data. For example, Pretty Good Privacy (PGP) can be used to send or save encrypted files securely, using encryption keys. PGP could be used to encrypt the data on it's way to the authorization center, in the same way email is often encrypted, or to encrypt files saved on the users device. Such PGP encryption could operate completely independently of the encryption described in FIG. 16. Such encryption might be used to assure privacy of transactions. Even if a credit card number cannot be fraudulently used, the cardholder might not be happy to have others see how, where, or when he spends his money. Similar privacy concerns occur for cards used for access or identification.

Note also that encryption of data in transit is of limited use for traditional plastic cards; the same cardholder information is transmitted each time and can be obtained from other sources such as billing statements, receipts, or someone looking over the cardholder's shoulder.

Bar Code Displays, Alternatives

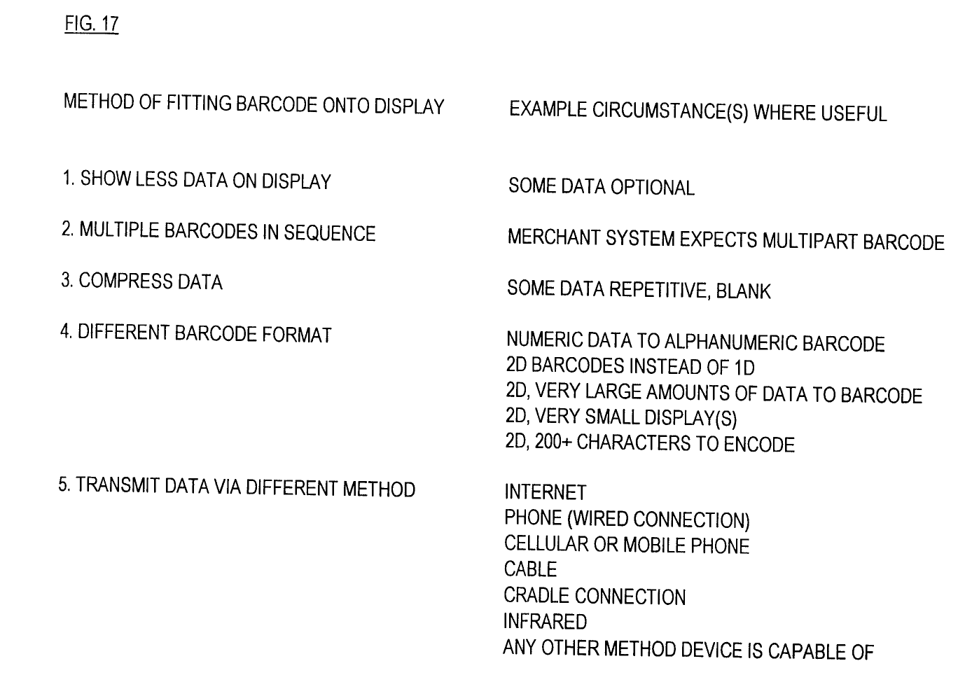

Most devices which can display text or images can also display bar codes. When bar codes are displayed along with the matching text, the screen can be read by humans or bar code scanners. Many portable devices have small displays, which may not have enough resolution to display all cardholder information simultaneously in a particular barcode format. FIG. 17 summarizes multiple approaches to overcoming this problem, which can often be used in combination:

1) Show less data on the display. For example, a credit card account might not display the cardholder name, but only the account number and expiration. Identification might only display name and driver's license number, but not birthdate or address.

2) Show the data as multiple barcodes in sequence. For example, cardholder name first, then account number and expiration second.

3) Compress the data. There are numerous compression algorithms which reduce the size of data files. In some cases, this may be sufficient to fit necessary barcode data on a small screen.

4) Change to a different barcode format. Different barcode formats can represent different characters in different ways. Persons skilled in the art of barcoding are familiar with these methods. Notably, some formats allow only numbers, while others allow text. Encoding purely numeric data can be done with fewer characters if letters are also available. For example, a 16 digit number can be represented in only 11 digits in a format which uses only numbers and 26 capital English letters. An ASCII-type barcode with 128 characters can represent the same 16 digit number in only 8 characters.

While one-dimensional barcodes (e.g., UPC, Code 39) are still the most common, numerous applications have arisen for two-dimensional barcodes. Two-dimensional barcodes can convey vastly more information in the same space than a traditional one-dimensional barcode. A 160×160 resolution screen (currently common in PDAs) can display two-dimensional barcode information for thousands of characters on one screen. This mechanism would allow copious data such as medical history to be barcoded on a single screen. Even small cellphone displays can show all the information on a typical credit card at one time using two-dimensional barcodes (e.g., Aztec Code by Longacre, UPS's Maxicode). A laptop pc is capable of displaying an entire book on one screen in certain two-dimensional formats. Such two-dimensional displays generally are not accompanied by human-readable text. Such text could be displayed on multiple, sequential screens if needed.

5) Transmit the data via a different method than barcode. Such methods include any method by which the device is capable of communicating. For example, modem, phone, infrared, or cable. The information could also be transmitted to another device, which then displays the barcode. An example would be a Palm device and a laptop computer; the larger display of the laptop can accommodate more data at one time.

I claim:

1. Software for use in financial transactions, comprising:
a computer-executable program embodied on a cellular or mobile telephone, the computer-executable program being programmed to:
(a) produce variable account numbers, and
(b) cause the cellular or mobile telephone to display account information in barcode form.

2. The software for use in financial transactions of claim 1, wherein:
the barcode is a two-dimensional barcode.

3. A portable device suitable for use in access control, identification, or financial transactions, with a self contained means for providing serial number of transaction code or time code comprising:
(a) a self-contained means for calculating said serial number of transactions or time code,
(b) a self-contained means for calculating an encrypted value in consideration of said serial number of transactions or time code, and
(c) a mechanism capable of displaying said encrypted value as one or more barcodes.

4. The portable device of claim 3, further comprising:
software programmed to enable the self contained display to display information which may change from one use of a card to the next.

5. The portable device of claim 4, wherein:
the software is upgradeable without having to replace the portable device.

6. The portable device of claim 4, wherein:
the software is capable of embodying multiple cards on the same portable device.

7. The portable device of claim 6, wherein:
the multiple cards have different security features.

8. The portable device of claim 3, wherein:
the self-contained display is configured to display a two-dimensional barcode.

9. The portable device of claim 2, wherein:
the software requires activation by a user of the portable device or by a financial institution.

10. The portable device of claim 3, wherein:
the portable device is capable of embodying multiple cards on the same portable device.

11. The portable device of claim 3, wherein:
the portable device is configured such that a plurality of the portable devices are capable of embodying a common card or account on the plurality of portable devices simultaneously.

12. The portable device of claim 3, wherein:
the portable device is configured to also be usable with a plastic card on a common account.

13. The portable device of claim 3, further comprising:
means for changing the appearance of the portable device to make an appearance of the portable device distinct from other devices of a similar model, wherein a change of the appearance relates to one or more cards embodied on the portable device.

14. The portable device of claim 3, wherein:
the portable device is a cellular or mobile telephone.

15. The portable device of claim 3, wherein:
the portable device is a personal digital assistant.

16. The portable device of claim 3, wherein:
the portable device is a laptop computer.

17. The portable device of claim 3, wherein:
the portable device is configured with encryption capabilities which are used by software to implement one or more encrypted cards.

18. A method for providing the portable device of claim 3 which is generally available for a fee to non-cardholders, comprising the step of:
providing one or more of the portable devices to cardholders for a price lower than the fee.

19. A method for providing the portable device of claim 3 which is generally available for a fee to non-cardholders, comprising the step of:
providing one or more of the portable devices to cardholders for free.

20. The portable device of claim 3, wherein:
the portable device is configured to be used in transactions occurring in person, via phone, or via the internet.

21. The portable device of claim 3, wherein:
the portable device is configured to be activated using an encryption key.

22. The portable device of claim 3, wherein:
the portable device is configured such that at least one account on the portable device can be activated using an encryption key.

23. The portable device of claim 3, wherein:
the portable device is configured such that at least one account on the portable device can be deactivated by deactivating an encryption key.

24. The portable device of claim 3, wherein:
the portable device is configured such that at least one account on the portable device can be deactivated remotely.

25. The portable device of claim 3, wherein:
the portable device is configured such that it can be deactivated remotely.

26. The portable device of claim 3, wherein:
the portable device is configured for use in combination with another device which can access at least one of account in common with said device.

27. The portable device of claim 3, wherein:
said portable device has a self contained means for displaying said encrypted value.

28. The portable device of claim 3, wherein:
the portable device is used for access control, or identification, but not for financial transactions.

29. The portable device of claim 3, furthermore comprising:
a mechanism for receiving prompts for potential access control, identification, or financial transactions from other software.

30. A program or programs suitable for use on a computer or other device for accessing the internet wherein said program or programs include:
(a) a method for accessing user or account information;
(b) a method for obtaining an account number which may vary from one transaction to the next;
(c) a method for displaying or transmitting said user or account information and/or account number; and
(d) a capability to generate nonvarying user or account information for transactions selected from the group consisting of deposits and merchant-specific account numbers.

31. The program or programs of claim 30, wherein:
the account number which may vary from one transaction to the next is obtained in consideration of a time code.

32. The program or programs of claim 30, wherein the program further includes:
a method for controlling access to the program on a user's computer.

33. The program or programs of claim 32, wherein:
the method for controlling access is a PIN number.

34. The program or programs of claim 32, wherein:
the method for controlling access is a password.

35. The program or programs of claim 32, wherein:
the method for controlling access is a physical key.

36. The program or programs of claim 32, wherein:
the method for controlling access is one or more questions asked of the user.

37. The program or programs of claim 32, wherein:
the method for controlling access allows access only at particular times.

38. The program or programs of claim 32, wherein:
transactions include accepting deposits.

39. The program or programs of claim 32, wherein:
the program or programs run on a desktop computer.

40. The program or programs of claim 30, wherein:
the account number which may vary from one transaction to the next is provided by the authorization center.

41. Software for producing variable account numbers, comprising:
a computer-executable program for a device, the computer-executable program being programmed to communicate data relating to transactions to other software on the same device and to generate variable account numbers wherein:
(a) account numbers used for a given cardholder or account may vary from one transaction to the next,
(b) validity of the account numbers can be confirmed by an authorization center,
(c) the account numbers contain the same number of characters as at least one nonvarying account number used by the same authorization system, and
(d) account numbers may be displayed in barcode form.

42. The software of claim 41, wherein:
a portion of the variable account number does not change from one transaction to the next.

43. The software of claim 41, wherein:
the variable account number is displayed using one or more two-dimensional barcodes.

44. The software of claim 41, wherein:
the other software is expense account software.

45. The software of claim 41, wherein:
the other software is accounting software.

46. The software of claim 41, wherein:
the other software is spreadsheet software.

47. A method for performing transactions using a deposit-only account number which does not vary from one transaction to the next for an account which uses variable account numbers for payments, the method comprising the steps of:
(a) instructing software to create a deposit-only account number,
(b) producing an account number which is only usable for deposits to a particular account.

48. The deposit-only account number of claim 47, wherein:
the deposit-only account number identifies an account without providing information needed to make payments from the account.

49. A system suitable for use in access control, identification, or financial transactions wherein:
(a) a cardholder causes a device to produce cardholder information which may vary from one transaction to the next,
(b) information is transferred or transmitted to one or more authorization centers in consideration of information displayed on said device in barcode form, and
(c) one or more authorization centers determine whether to complete a transaction in consideration of said information.

50. The system of claim 49, wherein:
the information which varies from one transaction to the next includes a variable account number.

51. The system of claim 50, wherein:
the one or more variable account numbers may be calculated in advance by an authorization center

52. The system of claim 49, wherein:
the system is embodied on a device selected from the group consisting of cellular phones, mobile phones, palm units, personal digital assistants and laptop computers.

53. The system of claim 52, wherein:
the system embodied on said device can complete a transaction via data on the display of said device without data transmission via cellular or mobile service.

54. The process of prompting a financial transaction on a portable device, wherein:
the portable device is capable of completing a financial transaction using account numbers which may vary from one transaction to the next.

55. The process of prompting a financial transaction of claim 54, wherein:
the prompting is performed via phone call, page or email

56. The process of prompting a financial transaction of claim 54, wherein:
the prompting may be caused solely by software on said portable device.

57. The process of prompting a financial transaction of claim 54, wherein:
the prompting may be caused by encrypted card software.

58. The process of prompting of a financial transaction of claim 54, furthermore comprised of:
communicating data relating to at least one prompted transaction to other software on the same device.

59. An encrypted card, comprising:
(a) one or more computing devices capable of performing encryption,
(b) user identification or account information, and
(c) at least one means for displaying or transmitting variable account numbers, wherein:
at least one of said means for displaying or transmitting variable account numbers is a barcode.

60. The encrypted card of claim 59, wherein said card is capable of displaying electronically:
(a) text,
(b) one or more images which may vary from one cardholder to the next.

61. The encrypted card of claim 60, wherein:
one or more images includes one or more images of a cardholder

62. The encrypted card of claim 60, wherein:
one or more images includes one or more images of two-dimensional barcodes.

63. The encrypted card of claim 60, wherein:
one or more images includes one or more images relating to a signature.

64. The encrypted card of claim 59, wherein:
the encrypted card is capable of person to person payment.

65. The encrypted card of claim 59, wherein:
variable account number contains the same number of characters as at least one nonvarying account number used by the same authorization system.

66. The encrypted card of claim 59, wherein: required software is downloaded for free.

67. The encrypted card of claim 59, wherein:
the card uses encryption technology embodied in the hardware of a portable computing device to perform encryption.

68. The encrypted card of claim 60, wherein:
the card can compress information which is originally numeric into fewer characters when displayed as a bar code.

69. The encrypted card of claim 59, further comprising:
an encryption key to activate at least one account.

70. The encrypted card of claim 59, wherein:
the card is capable of displaying a variable purely numeric account number using a barcode, and
said barcode is capable of displaying nonnumeric characters.

71. Using the barcode capable of displaying nonnumeric characters of claim 70, wherein:
a barcode can be displayed on a lower resolution device than a numeric barcode.

72. Using the barcode capable of displaying nonnumeric characters of claim 70, wherein:
the barcode capable of displaying nonnumeric characters can display more information on the same device than a numeric barcode.

73. Using the barcode capable of displaying nonnumeric characters of claim 70, wherein:
the barcode is a two-dimensional barcode.

74. The encrypted card of claim 59, further comprising:
software capable of running said encrypted card, wherein said software is installed on said computing device before sale.

75. The encrypted card of claim 59, further comprising:
software capable of running said encrypted card, wherein said software is installed by the user.

76. The encrypted card of claim 59, further comprising:
software capable of running said encrypted card, wherein said software is installed by an entity issuing one or more encrypted cards.

77. The encrypted card of claim 59, further comprising:
software capable of running said encrypted card, wherein said software is installed using an add-on device.

78. The encrypted card of claim 59, further comprising:
the capability to use a deposit-only account number which is constant from one deposit to the next.

79. A method for performing transactions using a merchant-specific account number which does not vary from one transaction to the next, comprising the steps of:
(a) instructing software to create a merchant-specific account number, and
(b) producing an account number which is only usable for transactions with a particular merchant for a particular cardholder

80. The method for performing transactions using a merchant-specific account number of claim 79, wherein:
the account number has limitations on its use selected from the group consisting of amount of transaction, maximum amount of a single transaction, maximum total amount of transactions, date of transaction or transactions, and time of transaction or transactions.

81. The method for performing transactions using a merchant-specific account number of claim 79, wherein:
the merchant-specific account number is used for transactions on an account which also uses variable account numbers.

82. Displaying a barcode relating to one or more financial transactions on a portable device selected from the group consisting of a cellular phone, a mobile phone, a palm device, or a personal digital assistant.

83. The display of a barcode of claim 82, wherein:
the barcode is a two-dimensional barcode.
